(19) United States
(12) Patent Application Publication
(10) Pub. No.: US 2025/0338115 A1
(43) Pub. Date: Oct. 30, 2025

(54) SECURE SIGNALING TECHNIQUES FOR AMBIENT POWER DEVICES

(71) Applicant: QUALCOMM Incorporated, San Diego, CA (US)

(72) Inventors: George CHERIAN, San Diego, CA (US); Alfred ASTERJADHI, San Diego, CA (US); Stephen Jay SHELLHAMMER, Ramona, CA (US); Sai Yiu Duncan HO, San Diego, CA (US); Abhishek Pramod PATIL, San Diego, CA (US); Bin TIAN, San Diego, CA (US); Rolf DE VEGT, San Francisco, CA (US)

(21) Appl. No.: 18/648,844

(22) Filed: Apr. 29, 2024

(51) Int. Cl. H04W 12/041; H04L 9/08

(52) U.S. Cl. CPC H04W 12/041; H04L 9/0869

(57) ABSTRACT

This disclosure provides methods, components, devices and systems for secure signaling techniques for ambient power devices. Some aspects more specifically relate to security and authentication for communications with one or more ambient power wireless devices. For example, when a query for data is received from another device, an ambient power wireless device may generate a random number that specific to that query. The query may include another random number and the ambient power wireless device may generate a transient key (for example, a security key) using both random numbers, a master security key, and an identifier (for example, a medium access control (MAC) address) associated with the ambient power wireless device. The transient key is specific to the received query and may be used to encrypt and/or provide message integrity check (MIC) bits for a message that includes the requested data and is sent in response to the query.

### TECHNICAL FIELD

This disclosure relates generally to wireless communication and, more specifically, to secure signaling techniques for ambient power devices. Various aspects relate generally to ambient power-enabled communications and ambient power deployments. Some aspects more specifically relate to signaling and techniques that provide security for ambient power-enable communications.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by an ambient power wireless device is described. The method may include receiving an energizing signal for supplying power to one or more radio frequency components of the ambient power wireless device, receiving a query message including a first random number, the query message indicating a request for data from the ambient power wireless device, generating a security key in response to receiving the query message, the security key generated using at least the first random number, a second random number different from the first random number, and a master security key, and transmitting, based on power applied to the one or more radio frequency components, a response message indicating the data and the second random number, where the data, the response message, or both are secured using the security key.

Another innovative aspect of the subject matter described in this disclosure can be implemented in an ambient power wireless device for wireless communications is described. The ambient power wireless device may include a processing system that includes processor circuitry and memory circuitry that stores code. The processing system may be configured to cause the ambient power wireless device to receive an energizing signal for supplying power to one or more radio frequency components of the ambient power wireless device, receive a query message including a first random number, the query message indicating a request for data from the ambient power wireless device, generate a security key in response to receiving the query message, the security key generated using at least the first random number, a second random number different from the first random number, and a master security key, and transmit, based on power applied to the one or more radio frequency components, a response message indicating the data and the second random number, where the data, the response message, or both are secured using the security key.

Another innovative aspect of the subject matter described in this disclosure can be implemented in another ambient power wireless device for wireless communications is described. The ambient power wireless device may include means for receiving an energizing signal for supplying power to one or more radio frequency components of the ambient power wireless device, means for receiving a query message including a first random number, the query message indicating a request for data from the ambient power wireless device, means for generating a security key in response to receiving the query message, the security key generated using at least the first random number, a second random number different from the first random number, and a master security key, and means for transmitting, based on power applied to the one or more radio frequency components, a response message indicating the data and the second random number, where the data, the response message, or both are secured using the security key.

Another innovative aspect of the subject matter described in this disclosure can be implemented in a non-transitory computer-readable medium storing code for wireless communications is described. The code may include instructions executable by one or more processors to receive an energizing signal for supplying power to one or more radio frequency components of the ambient power wireless device, receive a query message including a first random number, the query message indicating a request for data from the ambient power wireless device, generate a security key in response to receiving the query message, the security key generated using at least the first random number, a second random number different from the first random number, and a master security key, and transmit, based on power applied to the one or more radio frequency components, a response message indicating the data and the second random number, where the data, the response message, or both are secured using the security key.

Some examples of the method, ambient power wireless devices, and non-transitory computer-readable medium described herein may further include operations, features, means, or instructions for generating the second random number in response to the query message, where the security key may be specific to the received query message based on the second random number generated in response to the query message.

In some examples of the method, ambient power wireless devices, and non-transitory computer-readable medium described herein, the second random number may be generated using a time stamp as a seed.

In some examples of the method, ambient power wireless devices, and non-transitory computer-readable medium described herein, generating the security key may include operations, features, means, or instructions for generating the security key based on the first random number, the second random number, the master security key, and an identifier associated with the ambient power wireless device.

In some examples of the method, ambient power wireless devices, and non-transitory computer-readable medium described herein, the identifier includes a medium access control address.

Some examples of the method, ambient power wireless devices, and non-transitory computer-readable medium described herein may further include operations, features, means, or instructions for determining a set of message integrity check bits based on the security key, where the response message includes the set of message integrity check bits.

In some examples of the method, ambient power wireless devices, and non-transitory computer-readable medium described herein, the set of message integrity check bits may be included in the response message instead of a frame check sequence.

Some examples of the method, ambient power wireless devices, and non-transitory computer-readable medium described herein may further include operations, features, means, or instructions for encrypting the response message, the data, or both using the security key.

In some examples of the method, ambient power wireless devices, and non-transitory computer-readable medium described herein, where the response message may be transmitted within a time interval of receiving the query message.

In some examples of the method, ambient power wireless devices, and non-transitory computer-readable medium described herein, the energizing signal and the query message may be received from a same device.

In some examples of the method, ambient power wireless devices, and non-transitory computer-readable medium described herein, the energizing signal may be received from a first device and the query message may be received from a second device different from the first device.

Another innovative aspect of the subject matter described in this disclosure can be implemented in a method for wireless communications by a wireless communication device is described. The method may include transmitting, to an ambient power wireless device, a first query message including an indication of a first random number, the first query message indicating a request for data from the ambient power wireless device and receiving, from the ambient power wireless device, a first response message indicating at least the data and a second random number different from the first random number, where the data, the first response message, or both are secured in accordance with a security key that is based on at least the first random number, the second random number, and a master security key.

Another innovative aspect of the subject matter described in this disclosure can be implemented in a wireless communication device for wireless communications is described. The wireless communication device may include a processing system that includes processor circuitry and memory circuitry that stores code. The processing system may be configured to cause the wireless communication device to transmit, to an ambient power wireless device, a first query message including an indication of a first random number, the first query message indicating a request for data from the ambient power wireless device and receive, from the ambient power wireless device, a first response message indicating at least the data and a second random number different from the first random number, where the data, the first response message, or both are secured in accordance with a security key that is based on at least the first random number, the second random number, and a master security key.

Another innovative aspect of the subject matter described in this disclosure can be implemented in another wireless communication device for wireless communications is described. The wireless communication device may include means for transmitting, to an ambient power wireless device, a first query message including an indication of a first random number, the first query message indicating a request for data from the ambient power wireless device and means for receiving, from the ambient power wireless device, a first response message indicating at least the data and a second random number different from the first random number, where the data, the first response message, or both are secured in accordance with a security key that is based on at least the first random number, the second random number, and a master security key.

Another innovative aspect of the subject matter described in this disclosure can be implemented in a non-transitory computer-readable medium storing code for wireless communications is described. The code may include instructions executable by one or more processors to transmit, to an ambient power wireless device, a first query message including an indication of a first random number, the first query message indicating a request for data from the ambient power wireless device and receive, from the ambient power wireless device, a first response message indicating at least the data and a second random number different from the first random number, where the data, the first response message, or both are secured in accordance with a security key that is based on at least the first random number, the second random number, and a master security key.

Some examples of the method, wireless communication devices, and non-transitory computer-readable medium described herein may further include operations, features, means, or instructions for receiving a second query message from an application server, where transmitting the first query message to the ambient power wireless device may be triggered by the second query message.

In some examples of the method, wireless communication devices, and non-transitory computer-readable medium described herein, the second query message includes an indication of the first random number and transmitting the first query message including the first random number may be based on receiving the second query message including the indication of the first random number.

Some examples of the method, wireless communication devices, and non-transitory computer-readable medium described herein may further include operations, features, means, or instructions for transmitting a second response message to the application server based on receiving the first response message, the second response message including at least the data and the second random number.

Some examples of the method, wireless communication devices, and non-transitory computer-readable medium described herein may further include operations, features, means, or instructions for verifying that the first response message may be from the ambient power wireless device based on the master security key.

In some examples of the method, wireless communication devices, and non-transitory computer-readable medium described herein, verifying that the first response message may be from the ambient power wireless device may include operations, features, means, or instructions for decrypting the first response message, the data, or both, based on the security key and performing an integrity check for the first response message, the data, or both, based on the set of message integrity check bits.

Some examples of the method, wireless communication devices, and non-transitory computer-readable medium described herein may further include operations, features, means, or instructions for performing a channel access procedure, where transmitting the first query message and receiving the first response message may be based on the channel access procedure.

In some examples of the method, wireless communication devices, and non-transitory computer-readable medium described herein, the first response message may be received within a time interval of transmitting the first query message.

In some examples of the method, wireless communication devices, and non-transitory computer-readable medium described herein, the security key may be based on the first random number, the second random number, the master security key, and an identifier associated with the ambient power wireless device.

In some examples of the method, wireless communication devices, and non-transitory computer-readable medium described herein, the identifier includes a medium access control address.

Some examples of the method, wireless communication devices, and non-transitory computer-readable medium described herein may further include operations, features, means, or instructions for transmitting an energizing signal for supplying power to one or more radio frequency components of the ambient power wireless device, where receiving the first response message may be based on transmitting the energizing signal.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 shows a pictorial diagram of another example wireless communication network.

FIGS. 5A, 5B, 5C, 5D, 5E, 5F, and 5G show examples of signaling diagrams that support secure signaling techniques for ambient power devices.

FIG. 6 shows an example of a timing diagram that supports secure signaling techniques for ambient power devices.

FIG. 7 shows example frame formats that support secure signaling techniques for ambient power devices.

FIG. 8 shows an example of a timing diagram that supports secure signaling techniques for ambient power devices.

FIG. 9 shows an example of a signaling configuration that supports secure signaling techniques for ambient power devices.

FIG. 10 shows an example of a process flow that supports secure signaling techniques for ambient power devices.

FIG. 11 shows an example of a timing diagram that supports secure signaling techniques for ambient power devices.

FIG. 12 shows a block diagram of an example wireless communication device that supports secure signaling techniques for ambient power devices.

FIG. 13 shows a block diagram of an example wireless communication device that supports secure signaling techniques for ambient power devices.

FIGS. 14 and 15 show flowcharts illustrating example processes performable by or at an ambient power wireless device that supports secure signaling techniques for ambient power devices.

FIGS. 16 and 17 show flowcharts illustrating example processes performable by or at a wireless device that supports secure signaling techniques for ambient power devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Some wireless communication networks may support various deployments for ambient power-enabled communications (such as ambient power (AMP) deployments). In such deployments, one or more wireless communication devices may lack an internal power source (such as a battery) or may otherwise have relatively limited energy storage and/or other capabilities. Such devices may perform energy harvesting using one or more energy sources and/or signals to communicate data. In some examples, these devices may be relatively low-complexity devices (such as due to an environment in which the device operates, due to a functionality of the device, due to a form factor of the device, due to a relatively reduced cost of the device, among other examples) and may be referred to as ambient power wireless devices, energy-harvesting devices, ambient power tags, low-power devices, zero-power devices, ambient power-enabled Internet of Things (IoT) devices, AMP devices, or the like.

Deployments including one or more ambient power wireless devices may be associated with various configurations for supporting energy harvesting and ambient power-enabled communications. For example, one or more devices (such as one or more access points (APs), stations (STAs), relays, readers, or the like) may provide a signal (such as an energizing signal, an energizer signal) to an ambient power wireless device such that the ambient power wireless device harvests the energy from the signal and supplies power to (for example, powers up, activates) one or more radio frequency (RF) components of the ambient power wireless device for communications. After the RF components are powered up, data may be communicated between the ambient power wireless device and the one or more devices that provided the signal. Additionally, or alternatively, the ambient power wireless device may communicate with one or more other devices (such as one or more APs, STAs, relays, readers, or the like) that did not provide the energizing signal. In some examples, one or more additional devices (such as energizers, energizing devices), which may not communicate control information or data with the ambient power wireless device, may supply the energizing signals that are used for energy harvesting at the ambient power wireless devices.

In any case, signaling techniques that support efficient and low-power communications across deployment configurations may be desirable, particularly using signaling for ambient power wireless devices that is compatible and coexists with one or more wireless communication networks. Further, the relatively low complexity of some ambient power wireless devices may require techniques that ensure efficient and secure communications. Specifically, because some ambient power wireless devices may lack persistent memory capabilities (such as due to the absence of a power source for maintaining volatile memory, due to an absence of non-volatile memory, or the like), techniques may be needed to enable security and authentication for respective messages transmitted by the ambient power wireless devices (for example, because security and authentication information may not be re-used by a device that lacks power between transmissions).

Various aspects relate generally to ambient power-enabled communications and ambient power deployments. Some aspects more specifically relate to signaling and techniques that provide security for ambient power-enable communications. For example, to facilitate signaling to and from one or more ambient power-enabled wireless communication devices, signaling techniques may be defined to support efficient and secure communications that are compatible with various wireless communications networks. An ambient power wireless device may include one or more RF components that support ambient power-enabled communications. For example, an ambient power wireless device may include one or more ambient power RF components (such as an AMP radio) that support ambient power-enabled communications, including the harvesting of power from one or more transmitted signals, which is used to supply power to various components for communicating data. The ambient power wireless device may further include one or more RF components (such as a main radio, an 802.11-capable radio, or the like) that support communications in accordance with some wireless communication networks, such as networks that support the IEEE 802.11 family of wireless communication protocol standards. As such, the signaling described herein may enable the reception of one or more signals (such as energizing signals, control signals, wakeup signals) using the AMP radio, as well as the communication of data with one or more other devices using the AMP radio or the main radio of the ambient power wireless device.

Additionally, the techniques described herein may enable security and validation of messages received from one or more ambient power wireless devices. Because an ambient power wireless device may not have persistent memory storage, security and authentication for communications with an ambient power wireless device may be contained within individual messages sent by the ambient power wireless device. Here, the ambient power wireless device may be configured with a master security key (MSK) (or multiple MSKs) at the time of manufacture or during an onboarding/setup process and, when a query for data is received from another device, the ambient power wireless device may generate a random number (such as a nonce, an SNonce) that is specific to that query. In such examples, the query may include another random number (such as another nonce, an ANonce) and the ambient power wireless device may generate a transient key (such as a security key) using both random numbers, the MSK, and an identifier (such as a medium access control (MAC) address) associated with the ambient power wireless device. The transient key is specific to the received query and may be used to encrypt and/or provide message integrity check (MIC) bits for a message that includes the requested data and is sent in response to the query. The response may further include an indication of the random number generated by the ambient power wireless device, which may enable a receiving device (such as a reader, a server) that also has the MSK to decrypt the response.

Particular aspects of the subject matter described in this disclosure can be implemented to realize one or more of the following potential advantages. In some examples, by implementing one-shot (for example, per-transmission, per-message) security within respective messages sent by an ambient power wireless device, the described techniques can increase the security of data within a wireless communication network, particularly for devices that are unable to store authentication/security information between transmissions (such as ambient power wireless devices). For example, in accordance with the described techniques, each message sent by an ambient power wireless device may be secured by a query-specific transient key based on an MSK configured for the ambient power wireless device. As a result, only another device that is in possession of the MSK may have enough information to decrypt the message and/or authenticate that the response message is from the ambient power wireless device. Likewise, another device may be unable to impersonate the ambient power wireless device (for example, send transmissions that may otherwise appear to be from the ambient power wireless device, which may be malicious in nature), because a transmission from the would-be impersonating device may not be secured using the same techniques described herein (namely, generating a query-specific security key using the MSK, random numbers, and an identifier/address). Thus, for data transmitted by the ambient power wireless device, the described techniques may enable secured data transmission on a per-query basis, which may be authenticated as being sent by the ambient power wireless device. In some aspects, the random number generation and the use of the transient key by the ambient power wireless device may prevent “replay attacks” in which another device replicates data previously sent by the ambient power wireless device. That is, because the transient key is generated for every transmission, each transmission is uniquely secured and is not able to be replicated by other devices. Similarly, each transmission from the ambient power wireless device may be authenticated as being from that ambient power wireless device based on the presence of the transient key that is generated using the query-specific random number and one or more MSKs.

Further aspects of the subject matter described herein may enable signaling that accounts for configurations of different ambient power wireless devices. For example, the use of a relatively relaxed frame spacing described herein may enable enough time for an ambient power wireless device to process received control signaling and respond without consuming excessive power (for example, that may exceed the capabilities of the ambient power wireless device). Additionally, or alternatively, the described techniques may allow for ambient wireless devices to maintain low complexity and low cost while maintaining accurate and reliable communication.

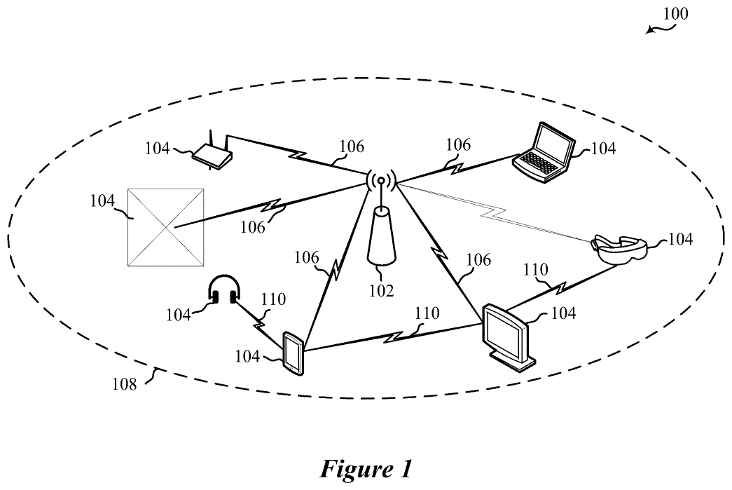

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHZ), FR3 (7.125 GHz-24.25 GHZ), FR4a or FR4-1 (52.6 GHz-71 GHZ), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHZ portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHZ channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

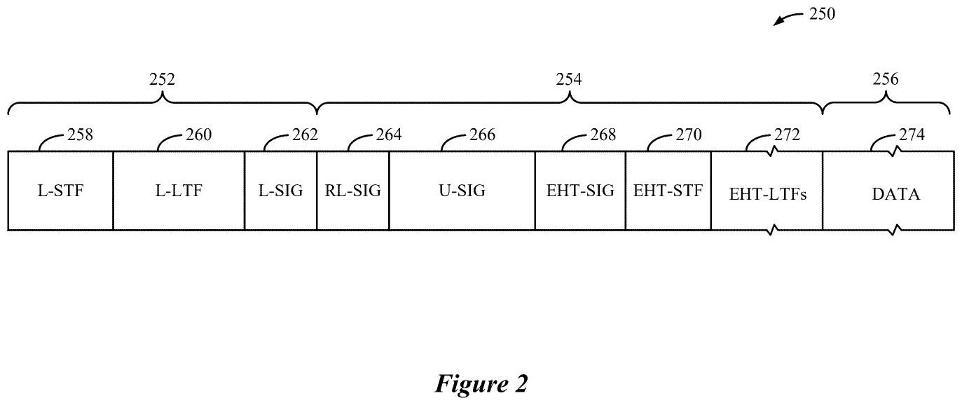

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an EHT signal field 268 (referred to herein as “EHT-SIG 268”). The presence of RL-SIG 264 and U-SIG 266 may indicate to EHT- or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version-dependent information for, other wireless communication protocol versions associated with amendments to the IEEE family of standards beyond EHT. For example, U-SIG 266 may be used by a receiving device (such as an AP 102 or a STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT-STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled uplink (UL) or downlink (DL) resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (for example, STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

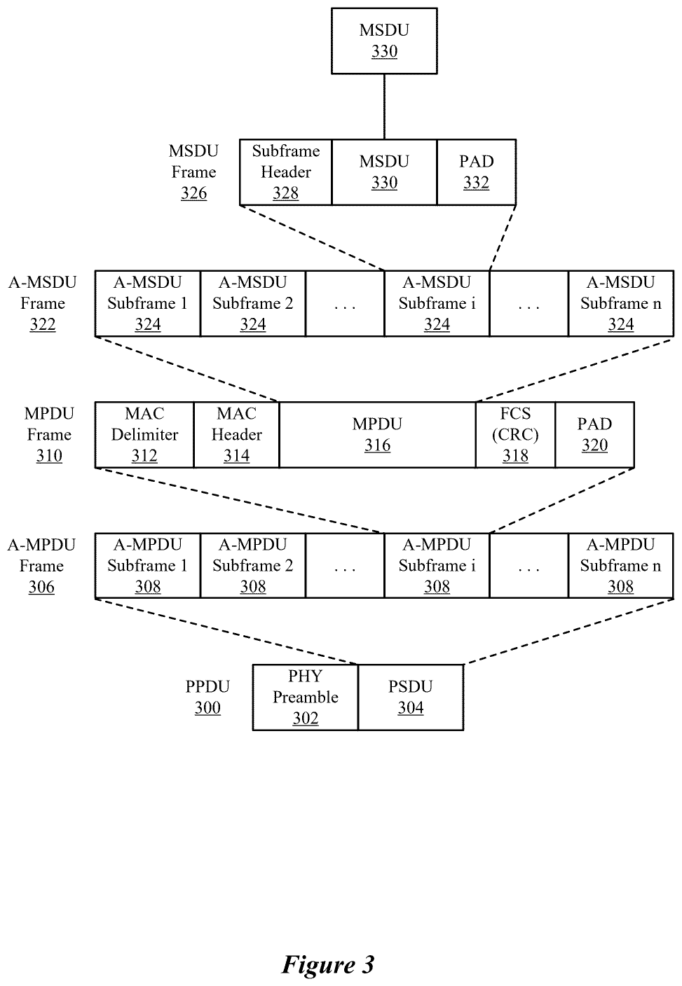

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (for example, identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (for example, identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (for example, the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (for example, the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Retransmission protocols, such as hybrid automatic repeat request (HARQ), also may offer performance gains. A HARQ protocol may support various HARQ signaling between transmitting and receiving wireless communication devices (for example, the AP 102 and the STAs 104 described with reference to FIG. 1) as well as signaling between the PHY and MAC layers to improve the retransmission operations in a wireless communication network. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a wireless communication network may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (for example, a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (for example, the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{TX} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (for example, in the form of a null data packet (NDP)) to the beamformee. An NDP is a PPDU without any data field. The beamformee may perform measurements for each of the N_{Tx}×N_{RX} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (for example, identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{TX} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (cMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the cMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the cMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHZ band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (such as packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (for example, via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The particular functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

In some environments, locations, or conditions, a regulatory body may impose a power spectral density (PSD) limit for one or more communication channels or for an entire band (for example, the 6 GHz band). A PSD is a measure of transmit power as a function of a unit bandwidth (such as per 1 MHZ). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (for example, duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

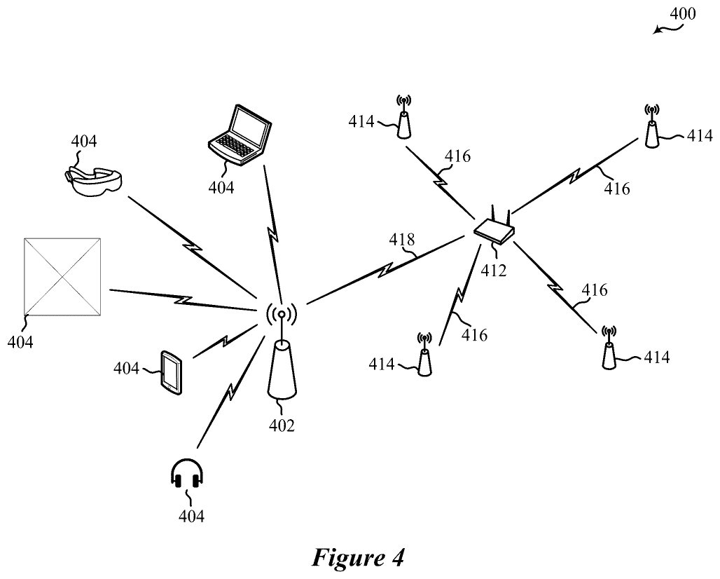

FIG. 4 shows a pictorial diagram of another example wireless communication network 400. According to some aspects, the wireless communication network 400 can be an example of a mesh network, an IoT network, or a sensor network in accordance with one or more of the IEEE 802.11 family of wireless communication protocol standards (including the 802.11ah amendment). The wireless communication network 400 may include multiple wireless communication devices 414, which in some implementations may include APs 402, STAs 404, or both. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and transmit such raw or processed data to an intermediate device 412 for subsequent processing or distribution. Additionally, or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a WLAN or a wireless (for example, cellular) wide area network (WWAN), which may, in turn, provide access to external networks including the Internet. For example, the intermediate device 412 may associate and communicate, over a Wi-Fi link 418, with an AP 102 of a wireless communication network 400, which also may serve various STAs 104. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

In some examples, one or more wireless communication devices may not have an internal battery or may have a relatively limited battery supply or other source of power. As such, these devices may be relatively lower-complexity devices associated with relatively reduced power consumption for wireless communications, for example, via unlicensed (for example, shared) RF spectrum bands. As an example, one or more environmental conditions (such as extreme environmental conditions, such as relatively high pressure, extremely high and/or low temperature, humid environments, to name a few) may make the inclusion of a battery in a wireless communication device unfeasible. In another example, various use cases may call for a relatively low-maintenance (or maintenance-free) wireless communication device. As such, these wireless communication devices may not include a battery so as to avoid regular battery replacement or other maintenance. Additionally, or alternatively, a form factor or other features (such as a device having relatively small dimensions (such as a thickness of 1 millimeter (mm) and area of several square centimeters), a low-cost device, a device associated with an extended life cycle, or the like) may result in the exclusion of a battery or other power source from the wireless communication device. In some cases, these devices may be relatively low-cost devices (such as a tag used for tracking and inventory). Such devices may have a variety of example use cases, including home monitoring (such as monitoring temperature, humidity, gas leakage), home security (such as detecting intruders approaching a residence), asset management (such as asset tracking, inventory), industrial and/or scientific applications (such as industrial wireless sensor networks, product line monitoring, environment monitoring), to name a few. In some cases, these devices may be referred to as ambient power wireless devices, energy-harvesting devices, ambient power tags, low-power devices, zero-power devices, ambient power-enabled IoT devices, AMP devices, or the like.

These devices having limited (or no) battery or other power source may accordingly be associated with relatively reduced power consumption (for example, ultra-low power consumption, less than 1 milliwatt (mW) power consumption, less than 100 microwatts (μW) power consumption), relatively low complexity (for example, having a relatively simplified RF and baseband architecture, limited memory, or the like), and relatively reduced performance (for example, utilizing relatively simplified waveform/modulation/coding schemes, relatively simplified protocol designs to support ultra-low power operation, or the like). As a result, the devices may use other means to power one or more RF components and/or integrated circuits (ICs) for wireless communications. For example, an ambient power wireless device may be powered via techniques such as energy harvesting from radio waves or other power sources. Such energy harvesting may utilize various sources of energy including electromagnetic energy sources, photovoltaic energy sources, thermal energy sources, vibrational energy sources, or a combination of these sources, among other examples. In one implementation, ambient energy from one or more RF spectrum bands (for example, a 2.4 Gigahertz (GHz) band, among others) may be used by a device to supply power to one or more RF components that are configured for wireless communications with one or more other devices (such as an AP 102, a STA 104, among other examples, each of which may be referred to as a reader). The device harvesting the energy may include one or more RF components associated with energy harvesting (for example, for receiving the signal(s) used to supply power) in addition to a set of RF components (for example, a main radio) used for the wireless communications. In other cases, the set of RF components may be used for both energy harvesting and wireless communications.

In some examples, ambient power wireless devices may be configured to support backscatter communication techniques. Backscatter communication techniques may involve a single waveform, which may define the structure and shape of information in transmitted signals, where a received signal is reflected (or backscattered) to enable one or more data transmissions. In some examples, backscatter communication techniques may use a continuous wave, which may be a sinusoidal wave that is modulated with an information-bearing signal to convey information. For example, one or more wireless devices (for example, a transmitting device, such as an AP 102 or a STA 104, and which may be referred to as a reader or other terminology) may select a waveform to use to modulate the carrier wave.

The continuous wave transmission to an ambient power wireless device may enable the ambient power wireless device to collect energy from the continuous wave transmission. The collected energy at the ambient power wireless device may reach some voltage (for example, IC voltage on) at which point the ambient power wireless device may turn on (for example, power up an IC, activate, supply power to). In some cases, the continuous wave transmission may be transmitted for some duration to power up the ambient power wireless device. After the duration, the transmitting device (or another device) may transmit an information signal (for example, including one or more commands) to the ambient power wireless device, where the information signal also may enable the ambient power wireless device to harvest energy and remain active (for example, powered on). The one or more commands may include instructions for the ambient power wireless device to transmit some signaling or information requested by the transmitting device. The transmitting device may transmit the continuous wave transmission to maintain the applied power (for example, powered up) state of the ambient power wireless device until a response to the one or more commands from the ambient power wireless device is received. In some examples, powering up the ambient power wireless device, maintaining the powered up state of the ambient power wireless device, and transmitting the power and carrier wave for modulation may use a same waveform.

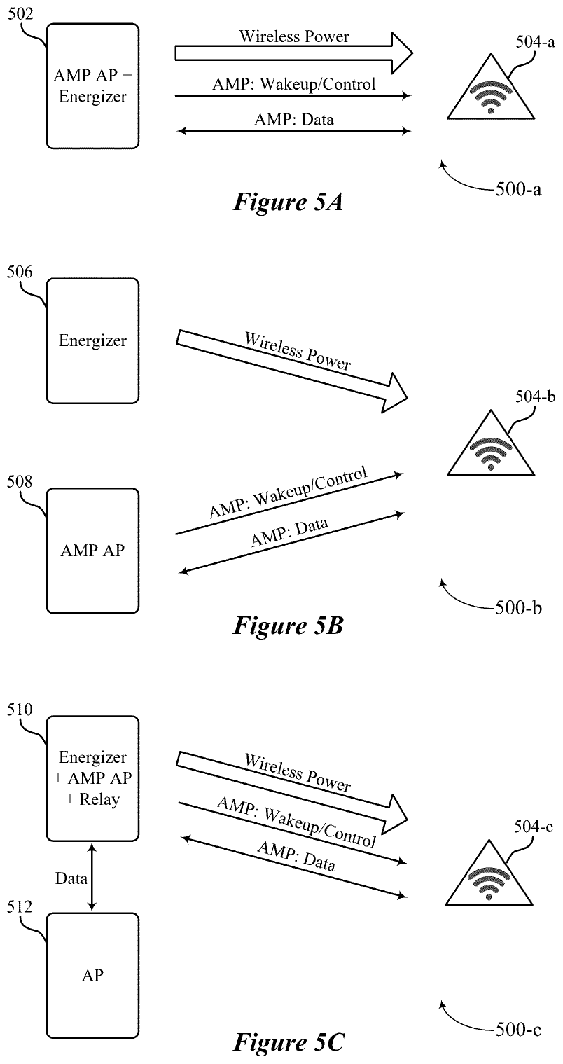

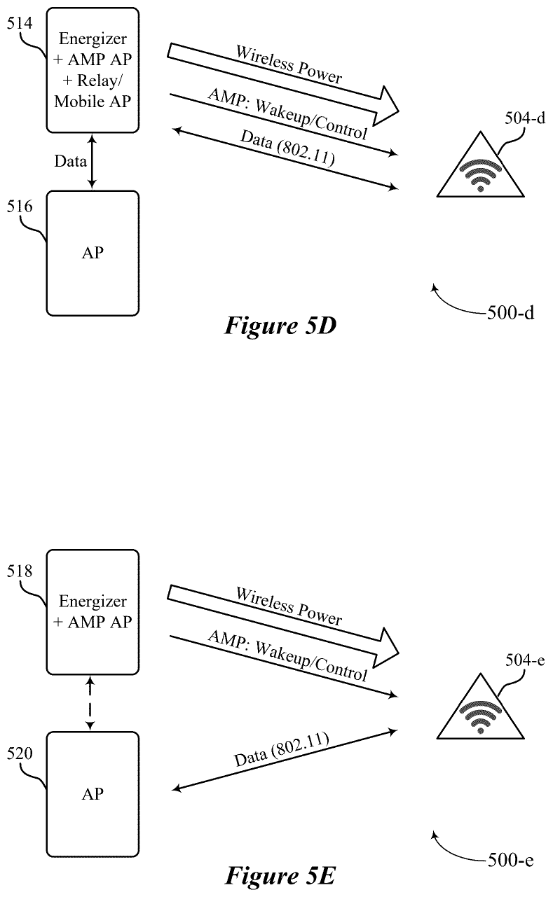

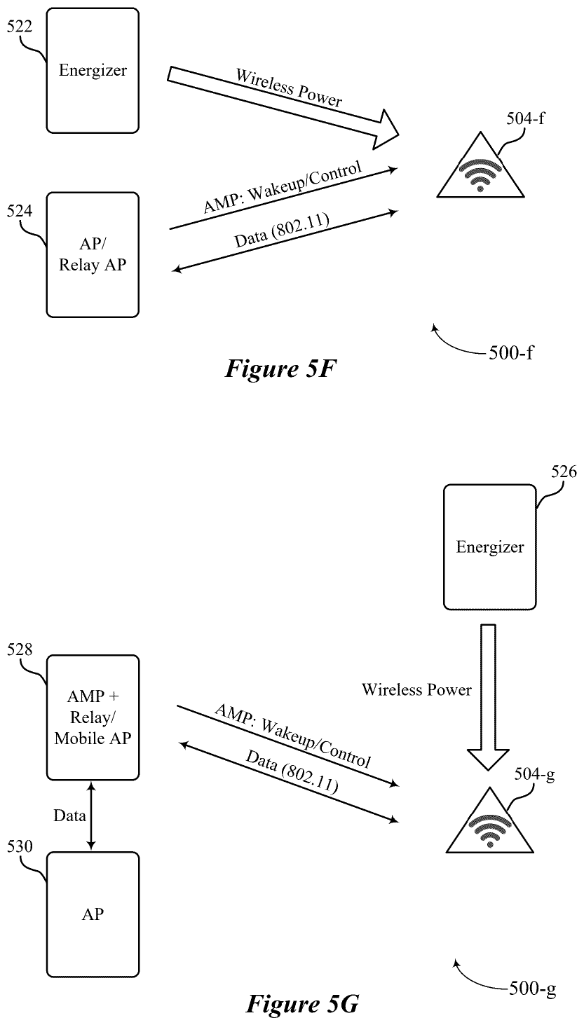

FIGS. 5A, 5B, 5C, 5D, 5E, 5F, and 5G show example signaling diagrams 500 (for example, 500-a, 500-b, 500-c, 500-d, 500-c, 500-f, 500-g) that support secure signaling techniques for ambient power devices. In some aspects, the signaling diagrams 500 may be examples of networks that support ambient power-enabled wireless communications. As such, each signaling diagram 500 may be an example of a respective deployment or configuration of one or more devices that enable the ambient power-enabled wireless communications. For example, each signaling diagram 500 may include at least one ambient power wireless device 504 (for example, an energy-harvesting device, an AMP tag, a low-power device, an AMP IoT device, an AMP device) and one or more other devices that provide an energizing signal (for example, an energizer signal) to the ambient power wireless device 504 and/or communicate data with the ambient power wireless device 504.

In some cases, an ambient power wireless device 504 may support of have one or more types of configurations for wireless communications. For example, in a first type of configuration of the ambient power wireless device 504, the ambient power wireless device 504 may only include RF components for ambient power-enabled communications (for example, an ambient power radio, AMP radio). Here, the ambient power wireless device 504 may lack support of, or functionality for, some types of data (for example, TCP data, IP data, QoS data). In such cases, the ambient power wireless device 504 may communicate data with one or more other devices using the RF components associated with the ambient power-enabled communications (for example, associated with energy harvesting or other low-power communication techniques). In a second type of configuration of the ambient power wireless device 504, the ambient power wireless device 504 may only include the RF components for the ambient-power-enabled communications but may support the exchange of various types of data frames for communicating data (such as TCP data frames, IP data frames, QoS data frames, among other examples). In a third type of configuration, the ambient power wireless device 504 may include the RF components associated with the ambient power-enabled communications, as well as RF components that support wireless communications in accordance with the IEEE 802.11 family of wireless communication protocol standards (for example, a main radio, an 802.11-capable radio, or the like). In such examples, the ambient power wireless device 504 may support the ambient power-enabled communications and various types of data transmission (such as TCP data, IP data, QoS data, among other examples) using one or more sets of RF components.

As illustrated in the pictorial diagram of FIG. 5A, the example signaling diagram 500-a may include a wireless communication device 502 and an ambient power wireless device 504-a. The wireless communication device 502 may provide power to the ambient power wireless device 504-a and communicate control signals and/or data with the ambient power wireless device 504-a. For example, the wireless communication device 502 may transmit one or more signals (for example, energizing signals) that are used by the ambient power wireless device 504-a to harvest energy from the signal(s) and supply power to one or more RF components of the ambient power wireless device 504-a for communications with the wireless communication device 502. Further, after the ambient power wireless device 504-a supplies power to the one or more RF components (for example, powers up at least one AMP radio) using the harvested energy, the wireless communication device 502 may transmit one or more wakeup signals and/or control signals for enabling communications between the ambient power wireless device 504-a and the wireless communication device 502. The wakeup signals and/or control signals may be received and/or processed by the ambient power wireless device 504-a via RF components associated with the ambient power-enabled communications (for example, an AMP radio, an AMP transceiver). The ambient power wireless device 504-a may communicate data with the wireless communication device 502 via the AMP radio. In some aspects, if there is no data to be communicated, the one or more energizing signals may be stopped (for example, paused, halted, interrupted), and the ambient power wireless device 504-a may subsequently power down (for example, due to an absence of power available for harvesting, until the one or more energizing signals are transmitted/received again). In some aspects, one or more servers may be connected to or otherwise in communication with the wireless communication device 502. In such implementations, the one or more servers may communicate with the wireless communication device 502, such as one or more query messages and/or one or more response messages associated with communicating with the ambient power wireless device 504-a.

In some aspects, the wireless communication device 502 may be referred to as a reader, AMP reader, or reader device, and the wireless communication device 502 may be an example of an AP (such as an AP 102), a network entity, a STA (such as a STA 104), a handheld device, a smart phone, a specialized AMP reader, or another device. Additionally, or alternatively, the wireless communication device 502 may be referred to as an AMP AP and/or energizer, which may support both the transmission of energizing signals to the ambient power wireless device 504-a and data exchange with the ambient power wireless device 504-a.

In FIG. 5B, the pictorial diagram of the example signaling diagram 500-b includes at least one energizer device 506 and at least one wireless communication device 508, where the energizer device 506 and the wireless communication device 508 are configured to support ambient power-enabled communications with an ambient power wireless device 504-b. The energizer device 506 (for example, energizer) may be configured to transmit one or more signals (for example, energizing signals) that are used by the ambient power wireless device 504-b to harvest energy and supply power to one or more RF components of the ambient power wireless device 504-a for communications with the wireless communication device 508. In such cases, the energizer device 506 may enable persistent or semi-persistent energy harvesting (for example, relatively long-term energy harvesting) for the ambient power wireless device 504-b. As such, the ambient power wireless device 504-b may be supplied with power in an approximately continuous manner, thereby enabling extended communications sessions (for example, the communication sessions may be expected to be maintained for some duration).

After the ambient power wireless device 504-b supplies power to the one or more RF components (for example, powers up at least one AMP radio) using the energizing signal(s) from the energizer device 506, the wireless communication device 508 may transmit one or more wakeup signals and/or control signals to enable communications between the ambient power wireless device 504-b and the wireless communication device 508. The wakeup signals and/or control signals may be received and/or processed by the ambient power wireless device 504-b using one or more RF components associated with the ambient power-enabled communications (for example, an AMP radio, an AMP transceiver). The ambient power wireless device 504-b may communicate data with the wireless communication device 508 via the AMP radio.

The energizer device 506 may be an example of an AP (such as an AP 102), a network entity, a STA (such as a STA 104), a handheld device, a smart phone, a specialized AMP device, or another device. The wireless communication device 508 may be referred to as a reader, AMP reader, or reader device, and the wireless communication device 508 may be an example of an AP (such as an AP 102), a network entity, a STA (such as a STA 104), a handheld device, a smart phone, a specialized AMP reader, or another device. Additionally, or alternatively, the wireless communication device 508 may be referred to as an AMP AP, which supports the exchange of data with the ambient power wireless device 504-b.

The pictorial diagram of the example signaling diagram 500-c shown in FIG. 5C may illustrate a configuration of one or more relay or relay-like devices that enable ambient power-enabled communication with an ambient power wireless device 504-c. For example, the signaling diagram 500-c may include a first wireless communication device 510 in communication with a second wireless communication device 512, where data may be communicated between the second wireless communication device 512 and the ambient power wireless device 504-c via the first wireless communication device 510.

The first wireless communication device 510 may transmit one or more signals (for example, energizing signals) that are used by the ambient power wireless device 504-c to harvest energy from the signal(s) and supply power to one or more RF components of the ambient power wireless device 504-c for communications with the first wireless communication device 510. After the ambient power wireless device 504-c supplies power to the one or more RF components (for example, powers up at least one AMP radio) using the harvested energy from the first wireless communication device 510, the first wireless communication device 510 may transmit one or more wakeup signals and/or control signals for enabling communications between the ambient power wireless device 504-c and the first wireless communication device 510. In some examples, the transmission of the wakeup signals and/or control signals may be triggered by the second wireless communication device 512, for example, when the second wireless communication device 512 has data to transmit to the ambient power wireless device 504-c or when the second wireless communication device 512 initiates the retrieval of data from the ambient power wireless device 504-c. As such, the first wireless communication device 510 may function as a relay for the second wireless communication device 512 and/or the ambient power wireless device 504-c. Additionally, or alternatively, the first wireless communication device 510 may communicate with the ambient power wireless device 504-c without relaying data to/from the second wireless communication device 512. The wakeup signals and/or control signals may be received and/or processed by the ambient power wireless device 504-c using RF components associated with the ambient power-enabled communications (such as an AMP radio, an AMP transceiver). The ambient power wireless device 504-c may communicate data with the first wireless communication device 510 via the AMP radio.

The first wireless communication device 510 may be an example of an AP (such as an AP 102), a network entity, a STA (such as a STA 104), a handheld device, a smart phone, a specialized AMP reader, or another device. The first wireless communication device 510 may, in some cases, be referred to as a reader or an AMP reader. Additionally, or alternatively, the first wireless communication device 510 may be referred to as an AMP AP, a mobile AP, a relay AP, an energizer, and/or a relay (such as a Wi-Fi relay, an 802.11 relay) that supports relaying and exchange of data with the ambient power wireless device 504-c and/or the second wireless communication device 512. The second wireless communication device 512 may be an example of an AP (such as an AP 102), a network entity, a STA (such as a STA 104), a handheld device, a smart phone, or another device. Additionally, or alternatively, the second wireless communication device 512 may be referred to as an 802.11 AP or some similar terminology, where the second wireless communication device 512 may support the exchange of data with the ambient power wireless device 504-c.

The pictorial diagram of the example signaling diagram 500-d shown in FIG. 5D may illustrate another configuration of one or more relay or relay-like devices that enable ambient power-enabled communication with an ambient power wireless device 504-d. For example, the signaling diagram 500-d may include a first wireless communication device 514 in communication with a second wireless communication device 516, where data may be communicated between the second wireless communication device 516 and the ambient power wireless device 504-d via the first wireless communication device 514. In the example of the signaling diagram 500-d, the data may be associated with the IEEE 802.11 wireless communication protocol standards.

In some examples, the first wireless communication device 514 may transmit one or more signals (for example, energizing signals) that are used by the ambient power wireless device 504-d to harvest energy from the signal(s) and supply power to one or more RF components of the ambient power wireless device 504-d for communications with the first wireless communication device 514. After the ambient power wireless device 504-d supplies power to the one or more RF components (for example, powers up at least one radio, such as a main radio, an 802.11-capable radio, or the like) using the harvested energy from the signal(s) from the first wireless communication device 514, the first wireless communication device 514 may transmit one or more wakeup signals and/or control signals for enabling communications between the ambient power wireless device 504-d and the first wireless communication device 514. The wakeup signals and/or control signals may be received and/or processed by the ambient power wireless device 504-d using RF components associated with the ambient power-enabled communications (for example, an AMP radio, an AMP transceiver). In some aspects, the first wireless communication device 514 may function as a WLAN relay, and the first wireless communication device 514 may support one or more functions for initiating AMP wake up on an AMP radio for downlink packets.

In some implementations, the transmission of the wakeup signals and/or control signals may be triggered by the second wireless communication device 516, for example, when the second wireless communication device 516 has data to transmit to the ambient power wireless device 504-d or when the second wireless communication device 516 initiates the retrieval of data from the ambient power wireless device 504-d. As such, the first wireless communication device 514 may function as a relay for the second wireless communication device 516 and/or the ambient power wireless device 504-d. Additionally, or alternatively, the first wireless communication device 514 may communicate with the ambient power wireless device 504-d without relaying data to/from the second wireless communication device 516. In some aspects, the ambient power wireless device 504-d may include both the AMP radio/RF components and one or more RF components associated with communicating 802.11 data (for example, a main radio, an 802.11-capable radio, or the like). In such implementations, the ambient power wireless device 504-d may communicate 802.11 data with the first wireless communication device 514 via the main radio. In some aspects, the 802.11 data may be sent to the second wireless communication device 516 via the first wireless communication device 514. Additionally, or alternatively, the 802.11 data may be sent to the ambient power wireless device 504-d from the second wireless communication device 516 via the first wireless communication device 514.

The first wireless communication device 514 may be an example of an AP (such as an AP 102), a network entity, a STA (such as a STA 104), a handheld device, a smart phone, a specialized AMP reader, or another device. The first wireless communication device 514 may, in some examples, be referred to as a reader. Additionally, or alternatively, the first wireless communication device 514 may be referred to as an AMP AP, a mobile AP, a relay AP, an energizer, and/or a relay (for example, a Wi-Fi relay, and 802.11 relay) that supports relaying and exchange of data with the ambient power wireless device 504-d and/or the second wireless communication device 516. The second wireless communication device 516 may be an example of an AP (such as an AP 102), a network entity, a STA (such as a STA 104), a handheld device, a smart phone, or another device. Additionally, or alternatively, the second wireless communication device 516 may be referred to as an 802.11 AP or some similar terminology, and the second wireless communication device 516 may support the exchange of data with the ambient power wireless device 504-d.

As shown in the pictorial diagram of the example signaling diagram 500-e of FIG. 5E, respective devices may provide energizing signals and communicate data with an ambient power wireless device 504-c. For example, the signaling diagram 500-e may include a first wireless communication device 518 and a second wireless communication device 520. The first wireless communication device 518 may provide one or more signals (for example, energizing signals, wakeup signals, control signals, or any combination thereof) to the ambient power wireless device 504-e, whereas data may be communicated (for example, directly communicated) between the second wireless communication device 520 and the ambient power wireless device 504-c. In the example of the signaling diagram 500-e, the data may be associated with the IEEE 802.11 wireless communication protocol standards (for example, 802.11 data).

As an example, the first wireless communication device 518 may transmit one or more signals (for example, energizing signals) that are used by the ambient power wireless device 504-e for energy harvesting and to supply power to one or more RF components of the ambient power wireless device 504-e for communications with the second wireless communication device 520. After the ambient power wireless device 504-e supplies power to the one or more RF components (for example, powers up at least one radio/transceiver, such as an AMP radio, a main radio, an 802.11-capable radio, or the like) using the harvested energy from the first wireless communication device 518, the first wireless communication device 518 may transmit one or more wakeup signals and/or control signals for enabling communications between the ambient power wireless device 504-e and the second wireless communication device 520. In some aspects, the wakeup signals and/or control signals may be received and/or processed by the ambient power wireless device 504-e using RF components associated with the ambient power-enabled communications (for example, the AMP radio, an AMP transceiver).

In some examples, the transmission of the wakeup signals and/or control signals may be coordinated with the second wireless communication device 520. For example, the first wireless communication device 518 and the second wireless communication device 520 may optionally communicate with one another and the energizing signals, the wakeup signals, and/or the control signals may be transmitted to the ambient power wireless device 504-e when the second wireless communication device 520 is to communicate data (such as 802.11 data) with the ambient power wireless device 504-c. In such implementations, the ambient power wireless device 504-c may include both the AMP radio/RF components and one or more RF components associated with communicating 802.11 data (such as a main radio, an 802.11-capable radio, or the like). The ambient power wireless device 504-e may communicate 802.11 data with the second wireless communication device 520 via the main radio, whereas the energizing signals, wakeup signals, and/or control signals may be communicated via the AMP radio. The 802.11 data may be exchanged between the second wireless communication device 520 and the ambient power wireless device 504-e without being relayed via the first wireless communication device 518.

The first wireless communication device 518 may be an example of an AP (such as an AP 102), a network entity, a STA (such as a STA 104), a handheld device, a smart phone, a specialized AMP reader, or another device. The first wireless communication device 518 may, in some implementations, be referred to as a reader or AMP reader. Additionally, or alternatively, the first wireless communication device 518 may be referred to as an AMP AP, a mobile AP, and/or an energizer. The second wireless communication device 520 may be an example of an AP (such as an AP 102), a network entity, a STA (such as a STA 104), a handheld device, a smart phone, or another device. Additionally, or alternatively, the second wireless communication device 520 may be referred to as an 802.11 AP or some similar terminology, and the second wireless communication device 520 may support the exchange of data with the ambient power wireless device 504-c.

In FIG. 5F, the pictorial diagram of the signaling diagram 500-f includes respective devices that may provide an energizing signal and communicate data with an ambient power wireless device 504-f. For example, the signaling diagram 500-f may include a first wireless communication device 522 and a second wireless communication device 524. The first wireless communication device 522 may provide one or more signals (such as energizing signals) to the ambient power wireless device 504-f, which may enable the ambient power wireless device 504-f to harvest energy and communicate with one or more other devices. For instance, one or more signals (such as wakeup signals, control signals, or any combination thereof) and data may be communicated (for example, directly communicated) between the second wireless communication device 524 and the ambient power wireless device 504-f. In the example of the signaling diagram 500-f, the data may be associated with the IEEE 802.11 wireless communication protocol standards (such as 802.11 data).

As an example, the first wireless communication device 522 may transmit one or more signals (such as energizing signals) that are used by the ambient power wireless device 504-f for energy harvesting to supply power to one or more RF components of the ambient power wireless device 504-f for communications with the second wireless communication device 524. After the ambient power wireless device 504-f supplies power to the one or more RF components (for example, powers up at least one radio, such as an AMP radio, a main radio, an 802.11-capable radio, or the like) using the harvested energy from the first wireless communication device 522, the second wireless communication device 524 may transmit one or more wakeup signals and/or control signals for enabling communications between the ambient power wireless device 504-f and the second wireless communication device 524. In some aspects, the wakeup signals and/or control signals may be received and/or processed by the ambient power wireless device 504-f using RF components associated with the ambient power-enabled communications (such as the AMP radio, an AMP transceiver). In some examples, the ambient power wireless device 504-f may include both the AMP radio/RF components and one or more RF components associated with communicating 802.11 data (such as a main radio, an 802.11-capable radio, or the like). In such implementations, the ambient power wireless device 504-f may communicate 802.11 data with the second wireless communication device 524 via the main radio, whereas the energizing signals, wakeup signals, and/or control signals may be communicated via the AMP radio. The 802.11 data may be exchanged between the second wireless communication device 524 and the ambient power wireless device 504-f without being relayed via the first wireless communication device 522.

The first wireless communication device 522 may be an example of an AP (such as an AP 102), a network entity, a STA (such as a STA 104), a handheld device, a smart phone, a specialized AMP device, or another device. The first wireless communication device 522 may be referred to as an energizer, energizing device, or similar terminology. The second wireless communication device 524 may be an example of an AP (such as an AP 102), a network entity, a STA (such as a STA 104), a handheld device, a smart phone, or another device. Additionally, or alternatively, the second wireless communication device 524 may be referred to as an 802.11 AP, a relay AP (for example, the second wireless communication device 524 may relay data to/from the ambient power wireless device 504-f and one or more other devices), or some similar terminology, and the second wireless communication device 524 may support the exchange of data with the ambient power wireless device 504-f.

The pictorial diagram of the example signaling diagram 500-g shown in FIG. 5G may illustrate a configuration of one or more relay or relay-like devices that enable ambient power-enabled communication with an ambient power wireless device 504-f, as well as one or more devices that are configured to provide one or more energizing signals to the ambient power wireless device 504-f. For example, the signaling diagram 500-g may include a first wireless communication device 526, a second wireless communication device 528, and a third wireless communication device 530 in communication with the second wireless communication device 528. Here, data may be communicated between the third wireless communication device 530 and the ambient power wireless device 504-g via the second wireless communication device 528.

The first wireless communication device 526 may transmit one or more signals (such as energizing signals) that are used by the ambient power wireless device 504-g to harvest energy from the signal(s) and supply power to one or more RF components of the ambient power wireless device 504-g for communications with the second wireless communication device 528. After the ambient power wireless device 504-g supplies power to the one or more RF components (for example, powers up at least one radio, such as an AMP radio, a main radio, an 802.11-capable radio, or the like) using harvested energy from the first wireless communication device 526, the second wireless communication device 528 may transmit one or more wakeup signals and/or control signals for enabling communications between the ambient power wireless device 504-g and the second wireless communication device 528. In some examples, the transmission of the wakeup signals and/or control signals may be triggered by the third wireless communication device 530, for example, when the third wireless communication device 530 has data to transmit to the ambient power wireless device 504-g or when the third wireless communication device 530 initiates the retrieval of data from the ambient power wireless device 504-g. The second wireless communication device 528 may, in some implementations, perform as a relay for the third wireless communication device 530 and/or the ambient power wireless device 504-g. Additionally, or alternatively, the second wireless communication device 528 may communicate with the ambient power wireless device 504-g without relaying data to/from the third wireless communication device 530. The wakeup signals and/or control signals may be received and/or processed by the ambient power wireless device 504-g using RF components associated with the ambient power-enabled communications (such as an AMP radio, an AMP transceiver). In some aspects, the ambient power wireless device 504-g may include both the AMP radio/RF components and one or more RF components associated with communicating 802.11 data (such as a main radio, an 802.11-capable radio, or the like). The ambient power wireless device 504-g may communicate 802.11 data with the second wireless communication device 528 via the main radio. In some examples, the 802.11 data may be sent to the third wireless communication device 530 via the second wireless communication device 528 (such as while the first wireless communication device 526 provides the energizing signa(s)). Additionally, or alternatively, the 802.11 data may be sent to the ambient power wireless device 504-g from the third wireless communication device 530 via the second wireless communication device 528 (such as while the first wireless communication device 526 provides the energizing signa(s)).

The first wireless communication device 526 may be an example of an AP (such as an AP 102), a network entity, a STA (such as a STA 104), a handheld device, a smart phone, a specialized AMP reader, or another device. The first wireless communication device 510 may, in some implementations, be referred to as an energizer or energizing device. In some examples, the second wireless communication device 528 may be an example of an AP (such as an AP 102), a network entity, a STA (such as a STA 104), a handheld device, a smart phone, a specialized AMP reader, or another device. Additionally, or alternatively, the second wireless communication device 528 may be referred to as an AMP AP, a mobile AP, a relay AP, and/or a relay (such as a Wi-Fi relay, an 802.11 relay) that supports relaying and exchange of data with the ambient power wireless device 504-g and/or the third wireless communication device 530. The third wireless communication device 530 may be an example of an AP (such as an AP 102), a network entity, a STA (such as a STA 104), a handheld device, a smart phone, or another device. Additionally, or alternatively, the third wireless communication device 530 may be referred to as an 802.11 AP or some similar terminology.

As described with reference to one or more of the signaling diagrams 500, respective implementations or scenarios may be possible for ambient power-enabled communications. For example, in a first implementation, an ambient power wireless device 504 may use an AMP radio (and AMP signaling) for both wakeup purposes and energy harvesting, and the ambient power wireless device 504 may use 802.11 protocols for data exchange with another device. Here, aspects of the signaling diagram 500-d, the signaling diagram 500-f, and the signaling diagram 500-g, as described with reference to FIGS. 5D, 5F, and 5G, respectively, may correspond to examples of the first implementation. In a second implementation, the ambient power wireless device 504 may use an AMP radio (and AMP signaling) for wake up purposes and the exchange of data with another device. Further, the energy harvesting by the ambient power wireless device 504 may be relatively short term (for example, on-demand, as needed), and the ambient power wireless device 504 may expect a session to be active when energy is provided to the ambient power wireless device 504. Aspects of the signaling diagram 500-a and the signaling diagram 500-c, as described with reference to FIGS. 5A and 5C, respectively, may correspond to examples of the second implementation. In a third implementation, the ambient power wireless device 504 may use an AMP radio (and AMP signaling) for wake up purposes and the exchange of data with another device. The energy harvesting by the ambient power wireless device 504 may be relatively persistent (for example, long term), and the ambient power wireless device 504 may accordingly expect to maintain a communication session. Aspects of the signaling diagram 500-b illustrated by FIG. 5B may correspond to examples of the third implementation.

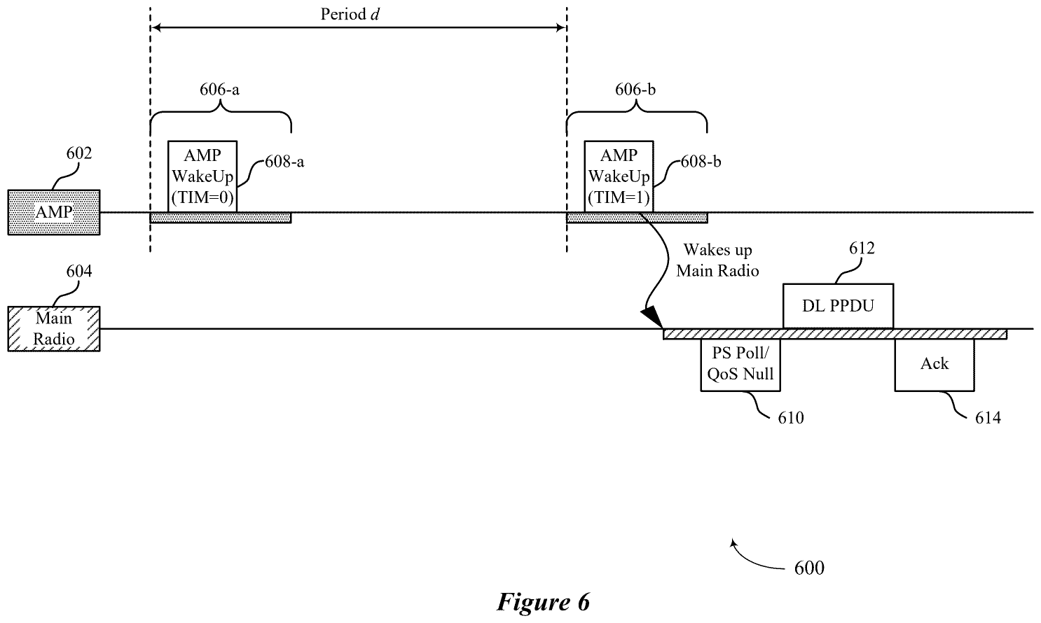

FIG. 6 shows an example of a timing diagram 600 that supports secure signaling techniques for ambient power devices. For example, the timing diagram 600 may be usable for wireless communications between a wireless communication device and an ambient power wireless device. The wireless communication device may be an example of the AP 102 and the STAs 104 described with reference to FIGS. 1 and 4, and/or an example of the wireless communication devices described with reference to FIGS. 5A through 5G. The ambient power wireless device may be an example of the ambient power wireless device 504 described with reference to FIGS. 5A through 5G.

In some aspects, the timing diagram 600 may correspond to aspects of the ambient power-enabled communications associated with the ambient power wireless device 504, for example, included in the signaling diagram 500-d, the signaling diagram 500-f, and/or the signaling diagram 500-g, as described with reference to FIGS. 5D, 5F, and 5G, respectively. For instance, the timing diagram 600 may be associated with communications with an ambient power wireless device having both an AMP radio 602 (such as one or more RF components configured for and supporting ambient-power enabled communications) and a main radio 604 (such as an 802.11 radio, a radio supporting 802.11 data). In such cases, one or more signals may be transmitted to the ambient power wireless device to both energize the RF components of the ambient power wireless device and to wake-up the ambient power wireless device for communications. In accordance with the timing diagram 600, the ambient power wireless device may receive one or more wake-up signals (such as one or more AMP wake-up frames for wake-up purposes).

The one or more wake-up frames may include an indication of a downlink packet for the ambient power wireless device. In some examples, the wake-up frame may be an example of a broadcast frame with a per-ambient power wireless device indication (for example, for addressing, where one or more ambient power wireless devices may be indicated). Additionally, or alternatively, the wake-up frame may be an example of a broadcast frame with a group indication (for example, for addressing, where a group of ambient power wireless devices may be indicated). In some other examples, the wake-up frame may be an example of a unicast frame, which may be used in cases where a per-ambient power wireless device schedule is used. In some examples, the wake-up frame may include information used for timing correction, such as a timing synchronization function (TSF) indication used to enable timing synchronization between devices. For example, the TSF may enable synchronization of timers for one or more wireless devices (such as readers) and one or more ambient power wireless devices (such as AMP tags) in the same BSS. In some examples, one or more aspects of the timing diagram 600 may be relatively relaxed to account for the capabilities of the ambient power wireless device. For example, a scheduler may be relaxed to account for some amount of clock drift (such as 1000 parts per million (ppm) clock drift, which may represent a peak frequency variation) associated with the ambient power wireless device, which may be relatively higher due to the need of the ambient power wireless device to harvest energy (for example, the ambient power wireless device may wake up to accommodate a relatively high ppm). That is, there may be times when the ambient power wireless device does not have power, resulting in increased clock drift. Additionally, or alternatively, the timing diagram may be associated with a timer-based next wake-up service period, for example to account for an amount of time for the ambient power wireless device to harvest energy from one or more received signals.

As an example, the ambient power wireless device may use a set of wake-up periods 606 (such as a first wake-up period 606-a, a second wake-up period 606-b, and so forth) in accordance with a periodicity, d, to monitor for signaling from one or more other wireless communication devices. The ambient power wireless device may periodically receive one or more energizing signals during (for example, in coordination with, at approximately the same time) the respective wake-up periods 606 to power up the AMP radio 602 for receiving another signal (such as a wake-up signal 608) transmitted by a wireless communication device (for example, the same wireless communication device that provides the energizing signal or another wireless communication device). Each wake-up signal 608 may include an indication of whether the ambient power wireless device is to wake-up to communicate data with the wireless communication device. During the first wake-up period 606-a, the ambient power wireless device may receive an energizing signal and may receive a first wake-up signal 608-a. The first wake-up signal 608-a may include the wake-up indication. The indication may be an example of a traffic indication map (TIM) included in a wake-up frame, where the TIM may be an example of a bitmap (such as a virtual bitmap) used to indicate to whether the ambient power wireless is to wake-up to transmit and/or receive data. During the first wake-up period 606-a, the wireless communication device may not be requesting any data from the ambient power wireless device, and the indication may therefore indicate that the ambient power wireless device may remain asleep (for example, using an indication of TIM=0).

During a second wake-up period 606-b, the ambient power wireless device may receive the one or more energizing signals and receive the wake-up signal 608-b, which may include an indication that the ambient power wireless device is to wake up and communicate (for example, based on an indication TIM=1 within the wake-up signal 608-b). In accordance with receiving the wake-up signal 608-b that includes the indication to communicate, the ambient power wireless device may use harvested energy to supply power to the main radio 604 and wake up to transmit or receive one or more messages. In some examples, the main radio (for example, after being woken up) may be used to harvest energy to supply power to one or more RF components. In one aspect, the ambient power wireless device may use the main radio to transmit a frame 610 (such as a control frame, a power save polling (PS-Poll) frame, a quality of service (QoS) Null frame, a null frame, or the like). The frame 610 may be used to request data from the wireless communication device and in response to the wake-up signal 608-b. Additionally, or alternatively, the frame 610 may be used to indicate to one or more wireless communication devices that the ambient power wireless device is awake and that the communication of additional frames may be initiated. In any case, the transmission of the frame 610 may enable the ambient power wireless device to receive a downlink PPDU 612 from the wireless communication device. In some examples, an acknowledgment frame 614 may be transmitted in response to the downlink PPDU 612. Further, one or more uplink PPDUs may be transmitted by the ambient power wireless device as a result of powering up the main radio 604 and/or data that may be available for transmission from the ambient power wireless device to the wireless communication device.

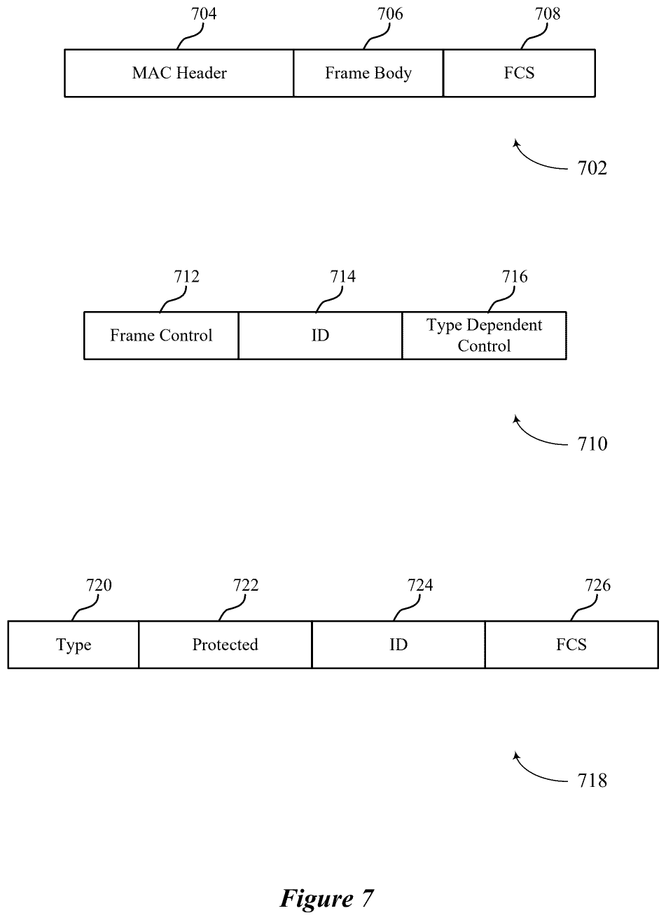

FIG. 7 shows example frame formats usable for wireless communication between a wireless communication device and an ambient power wireless device. For example, the wireless communication device may be an example of the AP 102 and the STAs 104 described with reference to FIGS. 1 and 4, and/or an example of the wireless communication devices described with reference to FIGS. 5A through 5G. The ambient power wireless device may be an example of the ambient power wireless device 504 described with reference to FIGS. 5A through 5G.

A wake-up signal frame format 702 may be used to indicate, to an ambient power wireless device, to wake up for the reception and/or transmission of data. In some examples, the wake-up signal frame format 702 may correspond to one or more wake-up signals, such as the wake-up signals 608 described with reference to FIG. 6. The wake-up signal frame format 702 may include a MAC header 704, a frame body field 706, and/or optionally a frame check sequence (FCS) 708. The MAC header 704 may include one or more additional fields. The frame body field 706 may include information specific to a respective wake up signal and/or frame type associated with waking up an ambient power wireless device. The FCS 708 may include one or more CRC bits (such as a 16-bit CRC). In some examples, the MAC header 704, the frame body field 706, and the FCS 708 may include or correspond to respective quantities of bits. In one example, the MAC header 704 may include 32 bits or may be less than 32 bits, the frame body field 706 may include a variable quantity of bits (such as based on a payload of the frame corresponding to the frame format 702), and the FCS 708 may include 16 bits. However, the MAC header 704, the frame body field 706, and the FCS 708 may have different quantities of bits when used for communications with one or more ambient power wireless devices, and the examples described herein should not be considered limiting to the scope of the claims or the disclosure.

In some aspects, the MAC header 704 of the wake-up signal frame format 702 may be associated with a MAC header field format 710. The MAC header field format 710 may, for example, include a frame control field 712, a first identifier field 714, and a type dependent control field 716. The frame control field 712 may identify a type of the frame and may include some control information associated with the frame. The first identifier field 714 may include one or more identifiers for the wake-up signal and corresponding frame. For instance, the first identifier field 714 may include a transmitter identifier (such as an identifier of a reader or other wireless communication device), a group identifier (such as an identifier for a group of ambient power wireless devices), an ambient power wireless device identifier (such as an identifier of an individual receiving ambient power wireless device), among other examples. The type dependent control field 716 may include some control information that may be based on the frame type, for example, where the frame type is associated with waking up an ambient power wireless device.

Each of the frame control field 712, the first identifier field 714, and the type dependent control field 716 may include or correspond to respective quantities of bits. For instance, the frame control field 712 may include 8 bits, the first identifier field 714 may include 12 bits, and the type dependent control field 716 may include 12 bits. However, the frame control field 712, the first identifier field 714, and the type dependent control field 716 may have different quantities of bits when used for communications with one or more ambient power wireless devices, and the examples described herein should not be considered limiting to the scope of the claims or the disclosure.

Additionally, or alternatively, another wake-up signal frame format 718 may be used to indicate, to an ambient power wireless device, to wake up for the reception and/or transmission of data. In some aspects, the wake-up signal frame format 718 may correspond to one or more wake-up signals, such as the wake-up signals 608 described with reference to FIG. 6. The wake-up signal frame format 718 may include a type field 720, a protected field 722, a second identifier field 724, and an FCS 726.

The type field 720 may indicate a type of the wake-up signal frame, where the type may correspond to one frame type from a set of two or more frame types. In some aspects, the protected field 722 may indicate whether indicates whether the information carried in the wake-up signal frame has been processed by a MIC algorithm. The second identifier field 724 may include one or more identifiers including, for example, an identifier of an ambient power wireless device. The FCS field may include one or more CRC bits (such as a 16-bit CRC). In some examples, the CRC may be calculated over all fields of the wake-up signal frame format 718. The type field 720, the protected field 722, the second identifier field 724, and the FCS 726 may each include or correspond to respective quantities of bits. For instance, the type field 720 may include 3 bits, the protected field may include 1 bit, the second identifier field 724 may include 12 bits, and the FCS 726 may include 16 bits. However, the type field 720, the protected field 722, the second identifier field 724, and the FCS 726 may have different quantities of bits when used for communications with one or more ambient power wireless devices, and the examples described herein should not be considered limiting to the scope of the claims or the disclosure.

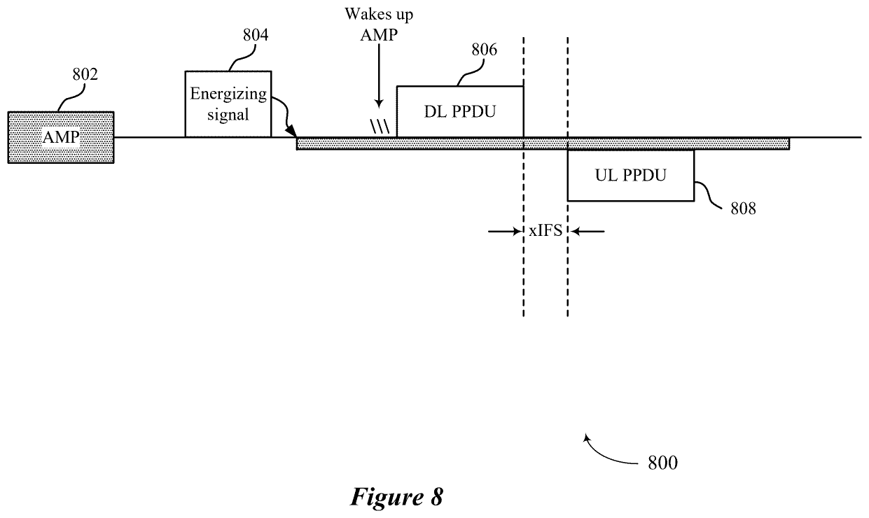

FIG. 8 shows an example of a timing diagram 800 that supports secure signaling techniques for ambient power devices. For example, the timing diagram 800 may be usable for wireless communications between a wireless communication device and an ambient power wireless device. The wireless communication device may be an example of the AP 102 and the STAs 104 described with reference to FIGS. 1 and 4, and/or an example of the wireless communication devices described with reference to FIGS. 5A through 5G. The ambient power wireless device may be an example of the ambient power wireless device 504 described with reference to FIGS. 5A through 5G.

In some aspects, the timing diagram 800 may correspond to aspects of the ambient power-enabled communications associated with the ambient power wireless device 504, for example, included in the signaling diagram 500-a and the signaling diagram 500-c described with reference to FIGS. 5A and 5C, respectively. For instance, the timing diagram 800 may be associated with communications with an ambient power wireless device having an AMP radio 802 (such as one or more RF components configured for and supporting ambient-power enabled communications), where the ambient power wireless device uses the AMP radio 802 (and AMP signaling) for wake up purposes and the exchange of data with another device. Further, the energy harvesting by the ambient power wireless device 504 may be relatively short term (for example, on-demand, as needed). In such cases, one or more signals, such as energizing signals 804, may be transmitted to the ambient power wireless device to both energize the RF components of the ambient power wireless device and to wake-up the ambient power wireless device for communications. In accordance with the timing diagram 800, the one or more energizing signals 804 may be used to wake up the RF components to enable wireless communications via the AMP radio 802 (such as one or more AMP transceivers).

In some examples, the ambient power wireless device may have relatively limited capabilities that affect the behavior of the ambient power wireless device and/or signaling associated with the ambient power wireless device. For example, the ambient power wireless device may lack some amount of data storage capabilities, where the ambient power wireless device may not have non-volatile memory for dynamic storage of data from one session to another, but the ambient power wireless device may have some non-volatile data stored (such as one-time data stored at the ambient power wireless device during on-boarding or an initial configuration). In some examples, any wireless communication device (such as reader, charging device, or the like) may solicit a response from the ambient power wireless device. In such cases, the ambient power wireless device may respond to queries using an uplink PPDU (such as in a scheduled mode). In some aspects, authentication of communications with the ambient power wireless device may be unidirectional, where an eliciting device (such as the reader, the wireless communication device) may validate the response from the ambient power wireless device. In such examples, the ambient power wireless device may respond with the data (for example, the same type of data, the same data), irrespective of which device sent the query to the ambient power wireless device. Moreover, the eliciting device may perform one or more channel access procedures (such as listen-before-talk (LBT)) to reserve the channel for both a query to and the response from the ambient power wireless device. Such techniques may avoid requiring the ambient power wireless device from monitoring a channel (for example, because the ambient power wireless device would need harvested energy in order to do so), which may further support low-power communications.

As an example, the ambient power wireless device may receive the energizing signal 804. The ambient power wireless device may harvest the energy from the energizing signal 804 to supply power to one or more RF components associated with the AMP radio 802. Based on harvesting the energy and “waking up” the AMP radio 802, the ambient power wireless device may receive a downlink PPDU 806 (for example, a query, a query message, a request, a control message, or the like). In some examples, the downlink PPDU 806 may be an example of a wake-up message or other control message that indicates to the ambient power wireless device that the ambient power wireless device is to communicate data. In response, the ambient power wireless device may transmit the uplink PPDU 808 that includes data responsive to the downlink PPDU 806. The uplink PPDU 808 may be transmitted some time duration after the downlink PPDU 806 is received. For example, the uplink PPDU 808 may be transmitted a duration corresponding to an interframe space (such as a short interframe space (SIFS) or some relaxed interframe space (xIFS)) after the downlink PPDU 806 is received. In some aspects, the xIFS may correspond to some multiple of an SIFS or may have some other duration (such that the duration may be tailored to the processing capabilities of the ambient power wireless device). Here, the xIFS may ensure that the ambient power wireless device operates in accordance with low-power communication techniques and refrains from consuming excess power for transmitting a response (for example, the uplink PPDU 808). In some aspects, the downlink PPDU 806 may set a NAV to protect the xIFS period (for example, to prevent another device from transmitting during the xIFS period). The ambient power wireless device may not transmit feedback (such as an acknowledgment (ACK)) in response to the downlink PPDU 806, which may support low-power and efficient ambient power-enabled communications. Additionally, or alternatively, retransmission procedures may not be implemented for the ambient power wireless device. Instead, the wireless communication device may send another query to the ambient power wireless device in examples where data from the ambient power wireless device may not have been received/decoded.

In some aspects, the downlink PPDU 806 may be defined by or associated with a PPDU format for communications with the ambient power wireless device. For instance, the downlink PPDU 806 may be associated with a threshold quantity of bits (such as a maximum number of bits). Further the downlink PPDU 806 may include one or more identifier fields, including an identifier of the receiving device or an identifier of the transmitting device, or both. The downlink PPDU 806 may further include a control type field and a payload. The downlink PPDU 806 may optionally include a set of MIC bits (such as overlap MIC bits used for security and authentication by the ambient power wireless device) in examples where a MIC security features is enabled for transmissions to the ambient power wireless device. The downlink PPDU 806 may further include a set of CRC bits. In some examples, the downlink PPDU 806 may exclude a frame check sequence.

The uplink PPDU 808 may likewise be defined by or associated with a PPDU format for communications by the ambient power wireless device. For example, the uplink PPDU 808 may be associated with a threshold quantity of bits (such as a maximum number of bits) and the uplink PPDU 808 may include one or more identifier fields, including an identifier of the receiving device or an identifier of the transmitting device, or both. The uplink PPDU 808 may further include a control type field and a payload (such as data indicating a price of an item, data indicating a location of an item, data indicating a temperature, among other examples). The uplink PPDU 808 may optionally include a set of MIC bits (such as overlap MIC bits used for security and authentication of transmissions from the ambient power wireless device) in examples where a MIC security features is enabled for transmissions from the ambient power wireless device. The uplink PPDU 808 may further include a set of CRC bits. In some examples, the uplink PPDU 808 may exclude a frame check sequence.

As described herein, the timing diagram 800 and the uplink PPDU 808 sent by the ambient power wireless device may be associated with one or more techniques that enable per-transmission authentication and security for respective messages transmitted by the ambient power wireless device. As an example, the ambient power wireless device may be configured with and store one or more MSKs (such as during an onboarding process and/or at the time of manufacturing) and, when the downlink PPDU 806 querying the ambient power wireless device is received from a wireless communication device, the ambient power wireless device may generate a random number that is specific to that downlink PPDU 806. The downlink PPDU 806 may include another random number and the ambient power wireless device may generate a transient key (such as a security key) using both random numbers, an MSK, and an identifier (such as a MAC address) associated with the ambient power wireless device. The transient key may therefore be specific to the received downlink PPDU 806 and may be used to encrypt and/or provide MIC bits for the uplink PPDU 808 that includes requested data and is sent in response to the downlink PPDU 806. The uplink PPDU 808 may further include an indication of the random number generated by the ambient power wireless device, which may enable a receiving device (such as a reader, a server) that also has the MSK to decrypt the response.

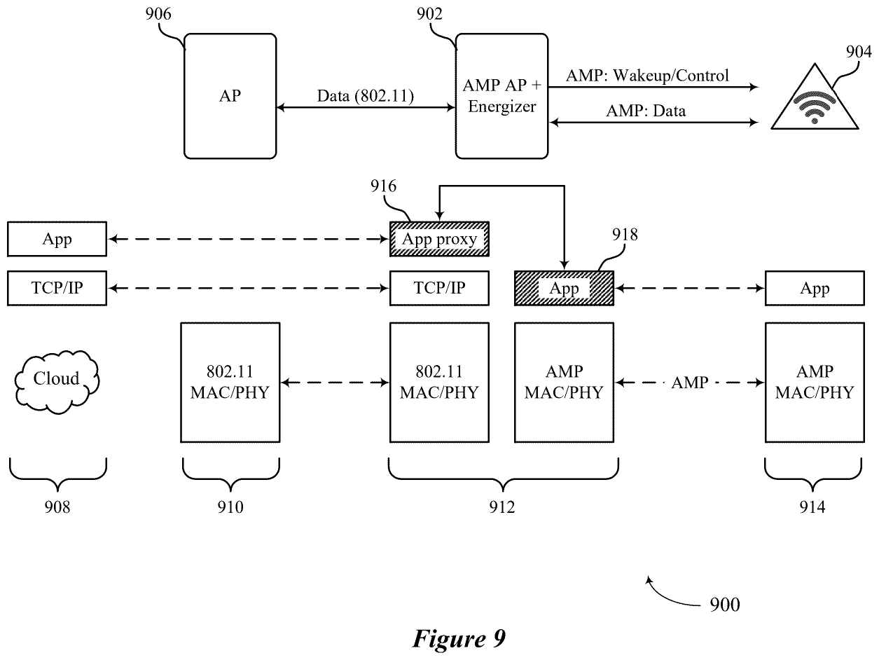

FIG. 9 shows an example of a signaling configuration 900 that supports secure signaling techniques for ambient power devices. For example, the signaling configuration 900 may be usable for wireless communications between one or more wireless communication devices and an ambient power wireless device. The signaling configuration 900 may be associated with communications by a first wireless communication device 902 and an ambient power wireless device 904, as well as a second wireless communication device 906.

In some aspects, the first wireless communication device 902 may relay data to or function as a relay for one or more other devices, such as the second wireless communication device 906. The first wireless communication device 902 may be an example of an AP (such as an AP 102), a network entity, a STA (such as a STA 104), a handheld device, a smart phone, a specialized AMP reader, or another device. The first wireless communication device 902 may, in some examples, be referred to as a reader or an AMP reader. Additionally, or alternatively, the first wireless communication device 902 may be referred to as an AMP AP, a mobile AP, a relay AP, an energizer, and/or a relay (such as a Wi-Fi relay, an 802.11 relay) that supports relaying and exchange of data with the ambient power wireless device 904 and/or the second wireless communication device 906. The second wireless communication device 906 may be an example of an AP (such as an AP 102), a network entity, a STA (such as a STA 104), a handheld device, a smart phone, or another device. Additionally, or alternatively, the second wireless communication device 906 may be referred to as an 802.11 AP or some similar terminology, where the second wireless communication device 906 may support the exchange of data with the ambient power wireless device 904 (such as via the first wireless communication device 902). In some examples, the signaling configuration 900 may correspond to aspects of the ambient power-enabled communications associated with the ambient power wireless device 504, for example, included in the signaling diagram 500-a and the signaling diagram 500-c, described with reference to FIGS. 5A and 5C, respectively.

The signaling configuration 900 may illustrate various sets of protocol layers associated with respective devices. For example, one or more servers in communication with the ambient power wireless device 904 may be associated with a first set of protocol layers 908 including, for example, an application layer and a TCP/IP layer. The one or more servers may include or be associated with a cloud interface, which may be associated with cloud computing and/or one or more distributed networks, among other examples. A second set of protocol layers 910 may be configured for use at the second wireless communication device 906, and may include MAC and/or PHY layers (such as MAC/PHY layers in accordance with one or more of the IEEE 802.11 standards). A third set of protocol layers 912 may be configured for use at the first wireless communication device 902, the third set of protocol layers 912 may include MAC and/or PHY layers (such as 802.11 MAC/PHY layers) and a TCP/IP layer, as well as an application proxy 916. Here, the MAC/PHY layers associated with the first wireless communication device 902 may be usable for communications with the MAC/PHY layers associated with the second wireless communication device 906. Likewise, the TCP/IP layer associated with the first wireless communication device 902 may be usable for communications via the TCP/IP layer in the first set of protocol layers 908 (for example, for communicating with a server). The application proxy 916 may be usable for communication with the application layer of the first set of protocol layers 908. Further, the third set of protocol layers 912 may include an application layer 918 and MAC and/or PHY layers associated with ambient power-enabled communications (for example, AMP PHY/MAC layers). A fourth set of protocol layers 914 may include an application layer and AMP PHY/MAC layers.

In some examples, transmissions to/from the server (such as a cloud interface) may be send in accordance with the TCP/IP protocol layer, but one or more TCP/IP headers may be relatively large (for example, 20 bytes, 60 bytes, 80 bytes, or the like), which may result in signaling overhead and/or potentially exceeding the processing capabilities and/or low-power requirements of the ambient power wireless device 904 (for example, a low-power and relatively low-complexity device). As such, in accordance with the signaling configuration 900, when the ambient power wireless device responds to a query, the ambient power wireless device 904 may transmit a response message in accordance with the PHY/MAC layers associated with ambient power-enabled wireless communications and the application layer, where the application layer 918 associated with the first wireless communication device 902 may provide the information received from the ambient power wireless device 904 to the application proxy 916. In some aspects, the application layer 918 may interpret AMP packets, and may wrap (for example, encapsulate, include) one or more such packets in a format (such as a generic format) with the assistance of the application proxy 916 for further transmission to the server (for example, to the Internet). Here, the information from the ambient power wireless device 904 may be sent to the server via the application proxy 916 and the TCP/IP layer of the first wireless communication device 902. As a result, the use of some frame formats and/or headers associated with increased overhead may be avoided for communications between the first wireless communication device 902 and the ambient power wireless device 904 while enabling signaling that is consistent and compatible with one or more other devices and/or protocols for communications between the first wireless communication device 902 and one or more other devices/servers.

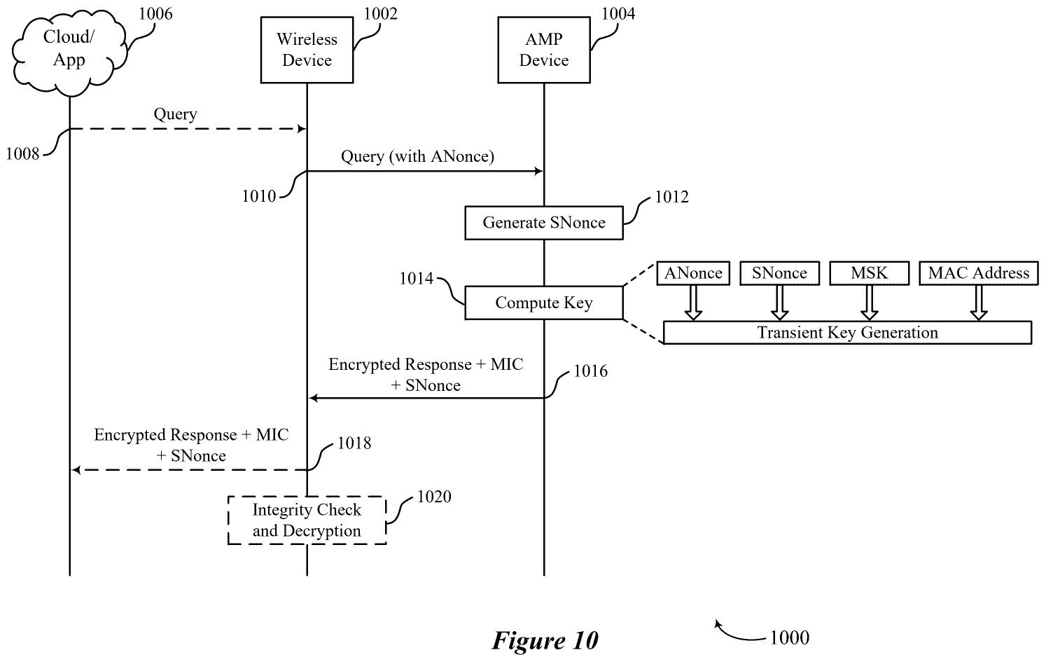

FIG. 10 shows a process flow 1000 that supports secure signaling techniques for ambient power devices. The process flow 1000 may implement aspects of, or be implemented by aspects of, the wireless communication network 100, the PPDU 250, the wireless communication network 400, and/or any one of the signaling diagrams 500. For example, the process flow 1000 may include a wireless communication device 1002 and an ambient power wireless device 1004. The wireless communication device 1002 may be an example of an AP (such as an AP 102), a network entity, a STA (such as a STA 104), a handheld device, a smart phone, a specialized AMP reader, or another device. In some examples, the ambient power wireless device 1004 may be an example of a STA (such as STA 104), a handheld device, a smart phone, an AMP device, an AMP tag, or another device. In some examples, the process flow 1000 may include a server 1006, which may be an example of a cloud server, a cloud computing environment, a distributed computing environment, an application server, and/or one or more other devices or network entities.

In the following description of process flow 1000, the operations may be performed in a different order than the order shown, or other operations may be added or removed from the process flow 1000. For example, some operations also may be left out of process flow 1000, may be performed in different orders or at different times, or other operations may be added to process flow 1000. Although communications of the process flow 1000 are shown occurring between a wireless communication device 1002, an ambient power wireless device 1004, and a server 1006, the operations of process flow 1000 also may be performed by one or more other wireless devices, network devices, or network functions.

As described herein, one or more techniques may be used to ensure security of messages transmitted by the ambient power wireless device 1004, and such techniques may take into account various conditions or parameters associated with the ambient power wireless device 1004. As an example, the ambient power wireless device 1004 may not have persistent memory capabilities and the ambient power wireless device 1004 may include an MSK that is programmed at the time of on-boarding. The ambient power wireless device 1004 may have relatively limited or low computational abilities, and therefore security techniques may be associated with relatively low-complexity procedures. Additionally, there may not be a need to secure/protect a query that is sent to the ambient power wireless device 1004, but the device sending the query may need to be able to validate a response message received from the ambient power wireless device 1004. For example, any device may be able to query the ambient power wireless device 1004 (such as to check the price of an item), and the device should be able to validate the response from the ambient power wireless device 1004.

The process flow 1000 may illustrate an example of one or more models used for querying the ambient power wireless device 1004. For example, a first model may be associated with a cloud-based query, where the wireless communication device 1002 operates in association with the server 1006 to obtain information from the ambient power wireless device. In this implementation, only the server 1006 and the ambient power wireless device may be in possession of (for example, store) an MSK used for security key generation. In a second model (for example, a direct query model), queries may be sent by the wireless communication device 1002, and the wireless communication device 1002 may validate the information from the ambient power wireless device 1004 directly. In this implementation, the wireless communication device 1002 and the ambient power wireless device may be in possession of (for example, store) the MSK. In some aspects, the process flow 1000 may be an example of one or more one-way authentication procedures, for example, where the ambient power wireless device 1004 may not directly perform authentication for the wireless communication device 1002 (or other devices) prior to communication. For instance, the ambient power wireless device 1004 may lack or have limited memory capabilities, and it may not be possible for the ambient power wireless device to maintain authentication information between sessions and/or transmissions by the ambient power wireless device 1004. One or more energizing signals (not shown) may be transmitted to the ambient power wireless device 1004 to enable the ambient power wireless device 1004 to harvest RF energy and supply power to one or more RF components for each session/transmission. In such examples, the energizing signals may be sent in an on-demand manner (for example, on a per-session basis) to enable communications by the ambient power wireless device 1004.

As an example of the first model (such as the cloud-based query model), at 1008 the server 1006 may send a query message (such as a query, a downlink PPDU) to the wireless communication device. The query message may, in some examples, be sent from the server 1006 via one or more other devices, such as one or more APs or other devices. In some aspects, the query message sent from the server 1006 may optionally include a first random number generated by the server 1006 or one or more network entities. The first random number may be a random number or a pseudo-random number and may be a number that an authentication protocol attaches to communications. The first random number may introduce randomness and/or time-stamping into communications and may be used for security and/or authentication. In some examples, the first random number may be referred to as a nonce, an AP-generated nonce (ANonce), or some similar terminology.

At 1010, the wireless communication device 1002 may transmit a query message (such as a query, a downlink PPDU) to the ambient power wireless device 1004, where the query message include the first random number (such as the nonce, the ANonce). The first random number included in the query message that is transmitted to the ambient power wireless device 1004 may be the same random number received from the server 1006 (such as when the query message from the server 1006 includes the first random number). Alternatively, the wireless communication device 1002 may generate the first random number for inclusion in the query message (such as when the query message from the server 1006 excludes the first random number). That is, the first random number may be generated (for example, calculated, computed) locally at the wireless communication device 1002 if the first random number is not provided by the server 1006. In an example of the second model (such as the direct-query model), the wireless communication device 1002 may transmit the query message at 1010 to the ambient power wireless device 1004 without receiving signaling from the server 1006 (for example, a presence of the server 1006 may be optional).

At 1012, after receiving the query message from the wireless communication device 1002 (for example, based on harvesting energy from one or more signals), the ambient power wireless device 1004 may generate a second random number. The second random number may be a random number or a pseudo-random number. In some examples, the second random number may be referred to as a nonce, an STA-generated nonce (SNonce), or some similar terminology. In some aspects, the random number may be generated using a time stamp as a seed, where the time stamp may correspond to the reception of the query message at the ambient power wireless device 1004.

At 1014, the ambient power wireless device 1004 may generate (for example, compute, calculate, determine) a security key in response to receiving the query message. In some aspects, the security key may be referred to as a transient key or some other terminology. The security key may be computed using a set of one or more parameters including, for example, the first random number, the second random number, an MSK, and an identifier, or the like. In some aspects, the identifier may be an example of a MAC address associated with the ambient power wireless device 1004, or some other identifier or address. In some aspects, multiple MSKs may be provisioned in the ambient power wireless device 1004. For example, different MSKs may be used for one or more associated applications (such as cloud applications). In such implementations, an MSK associated with the relevant application and/or data being requested (for example, by the query) may be used for the security key. In some examples, one or more fields may be included in the query message that indicate an identifier (e.g., a server identifier, an application identifier) so that the ambient power wireless device 1004 may select the MSK corresponding to the query message (for example, corresponding to the server 1006, corresponding to the application, or the like). In such cases, the MSK used for the security key generation may be specific to the data being transmitted by the ambient power wireless device 1004. Thus, the query message(s) at 1008 and/or 1010 may include a server identifier (for example, as an optional field of the query message), and the server identifier may assist the ambient power wireless device 1004 in selecting the corresponding MSK in implementations where the ambient power wireless device 1004 is provisioned with multiple MSKs.

The MSK may be a key that is stored by the ambient power wireless device 1004 (for example, at initial set up, via initial configuration). Further, the MSK may be stored or otherwise known by one or more other devices in communication with the ambient power wireless device 1004, such as the wireless communication device 1002 and/or the server 1006. For instance, under the second model (for example, the direct-query model) signaling received from the server 1006 may be optional (for example, the described techniques may be performed without involvement of the server 1006), and the wireless communication device 1002 may accordingly be in possession of (for example, store, retain) the MSK. Additionally, or alternatively, the server 1006 may be in possession of the MSK, such as in accordance with the first model (for example, the cloud-based query model).

The ambient power wireless device 1004 may generate the security key for encrypting a response message. Additionally, or alternatively, the ambient power wireless device may generate the security key for a set of MIC bits that may be used for enabled MIC procedures associated with the transmission of the response message. Because the second random number (and therefore the security key generated using the second random number) is generated each time a query message is received by the ambient power wireless device, the security key may be query-specific and may enable enhanced security for transmissions by the ambient power wireless device 1004. Additionally, because the security key is generated using the MSK that is only known by either the server 1006 or the wireless communication device 1002, other devices may not be able to decrypt transmissions from the ambient power wireless device 1004 that are encrypted and/or include the MIC bits based on the security key. Similarly, another (potentially malicious) device would not be unable to impersonate the ambient power wireless device 1004 because the other device does not have the MSK. Thus, the described per-message (for example, one-shot, one-time) security techniques may enable both authentication and security for messages transmitted by a device that is unable to store authentication information between sessions, such as the ambient power wireless device 1004.

At 1016, the ambient power wireless device 1004 may transmit the response message (for example, an uplink PPDU) to the wireless communication device 1002. The response message may be transmitted in response to the query message, and may be encrypted and/or include the set of MIC bits for securing the response message. The response message may further indicate the second random number generated by the ambient power wireless device.

At 1018, the wireless communication device 1002 may optionally send the response message to the server 1006 (for example, in accordance with the first model, the cloud-based query model). In such implementations, the server 1006 may use the MSK and other information (such as the first random number, the second random number included in the response message, the identifier, or any combination thereof) to decrypt the response message and/or data included in a payload of the response message. Additionally, or alternatively, the server 1006 may perform an integrity check for the response message (for example, based on the set of MIC bits). Such procedures may enable the server 1006 to verify (for example, validate) that the response message is from the ambient power wireless device 1004 and not from another (potentially malicious) device.

Additionally, or alternatively, at 1020, the wireless communication device 1002 may perform an integrity check and/or decryption for the response message and/or data included in the response message. For instance, in accordance with the second model (for example, the direct-query model), the wireless communication device 1002 may have the MSK, and the wireless communication device 1002 may use the MSK and other information (for example, the first random number, the second random number included in the response message, the identifier, or any combination thereof) to decrypt the response message and/or data included in a payload of the response message. Likewise, the wireless communication device 1002 may perform an integrity check for the response message (for example, based on the set of MIC bits). Such procedures may enable the wireless communication device 1002 to verify (for example, validate) that the response message is from the ambient power wireless device 1004 and not from another (potentially malicious) device. Accordingly, the described security techniques may enable efficient authentication of messages sent from the ambient power wireless device 1004.

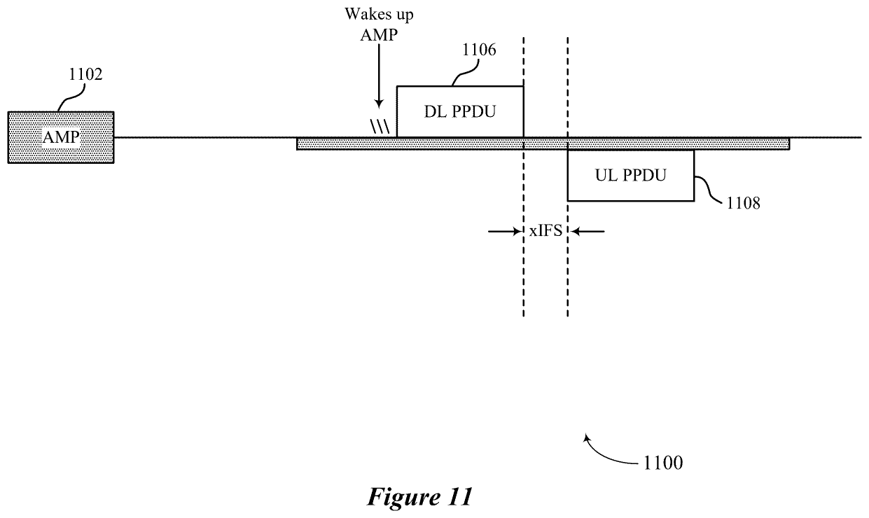

FIG. 11 shows an example of a timing diagram 1100 that supports secure signaling techniques for ambient power devices. For example, the timing diagram 1100 may be usable for wireless communications between a wireless communication device and an ambient power wireless device. For example, the wireless communication device may be an example of the AP 102 and the STAs 104 described with reference to FIGS. 1 and 4, and/or an example of the wireless communication devices described with reference to FIGS. 5A through 5G. The ambient power wireless device may be an example of the ambient power wireless device 504 described with reference to FIGS. 5A through 5G.

In some aspects, the timing diagram 1100 may correspond to aspects of the ambient power-enabled communications associated with the ambient power wireless device 504, for example, included in the signaling diagram 500-b illustrated by FIG. 5B. For instance, the timing diagram 1100 may be associated with communications with an ambient power wireless device having an AMP radio 1102 (such as one or more RF components configured for and supporting ambient-power enabled communications), where the ambient power wireless device uses the AMP radio 1102 (and AMP signaling) for wake up purposes and the exchange of data with another device. Here, the energy harvesting by the ambient power wireless device 504 may be ongoing such that a communication session may be relatively persistent (for example, due to the relatively continuous presence of one or more energizing signals). In such implementations, one or more signals, such as energizing signals (not shown), may be transmitted to the ambient power wireless device to both energize the RF components of the ambient power wireless device and to wake-up the ambient power wireless device for communications. In accordance with the timing diagram 1100, the one or more energizing signals may be used to wake up the RF components to enable wireless communications via the AMP radio 1102 (such as one or more AMP transceivers).

In some examples, the ambient power wireless device may have one or more capabilities that affect the behavior of the ambient power wireless device and/or signaling associated with the ambient power wireless device. For example, the ambient power wireless device may have some capability to store data, where the ambient power wireless device may have an ability to store dynamic data from one session to another. In some examples, only wireless communication devices (such as readers, charging devices, or the like) that are paired with the ambient power wireless device may solicit a response from the ambient power wireless device. In such cases, the ambient power wireless device may respond to queries using an uplink PPDU (such as in the scheduled mode). In some aspects, authentication of communications with the ambient power wireless device may be completed in accordance with bidirectional security techniques. Here, signaling to and from the ambient power wireless device may support integrity protection and/or encryption. In such examples, encryption may be performed at an application level, and security techniques may correspond to those supported by one or more IEEE 802.11 wireless communication protocol standards. In some aspects, an eliciting device may perform one or more channel access procedures (such as LBT) to reserve the channel for both a query to and the response from the ambient power wireless device.

As an example, the ambient power wireless device may receive one or more energizing signals used for energy harvesting to supply power to one or more RF components associated with the AMP radio 1102. Based on harvesting the energy and “waking up” the AMP radio 1102, the ambient power wireless device may receive a downlink PPDU 1106 (such as a query, a query message, a request, a control message, or the like). In some examples, the downlink PPDU 1106 may be an example of a wake-up message or other control message that indicates to the ambient power wireless device that the ambient power wireless device is to communicate data. In response, the ambient power wireless device may transmit the uplink PPDU 1108 that includes data responsive to the downlink PPDU 1106. The uplink PPDU 1108 may be transmitted some time duration after the downlink PPDU 1106 is received. For example, the uplink PPDU 1108 may be transmitted a duration corresponding to an interframe space (such as an SIFS or some xIFS) after the downlink PPDU 1106 is received. In some aspects, the xIFS may correspond to some multiple of an SIFS or may have some other duration (such that the duration may be tailored to the processing capabilities of the ambient power wireless device). The xIFS may, for example, be a duration between 16 us and 24 μs, or some other duration. Here, the xIFS may ensure that the ambient power wireless device operates in accordance with low-power communication techniques and refrains from consuming excess power for transmitting a response (such as the uplink PPDU 1108). In some aspects, the ambient power wireless device may transmit feedback (such as an ACK, a basic ACK) in response to the downlink PPDU 1106, which may support low-power and efficient ambient power-enabled communications. In some examples, the ambient power wireless device may communicate using a single MPDU (such as where aggregated MPDUs may not be used for the ambient power-enabled communications).

In some aspects, the downlink PPDU 1106 may be defined by or associated with a PPDU format for communications with the ambient power wireless device. For instance, the downlink PPDU 1106 may be associated with a threshold quantity of bits (such as a maximum number of bits). Further the downlink PPDU 1106 may include one or more identifier fields, including an identifier of the receiving device or an identifier of the transmitting device, or both. The downlink PPDU 1106 may further include a control type field and a payload. The downlink PPDU 1106 may optionally include a set of MIC bits (such as overlap MIC bits used for security and authentication by the ambient power wireless device) in implementations where a MIC security features is enabled for transmissions to the ambient power wireless device. The downlink PPDU 1106 may further include a set of CRC bits.

The uplink PPDU 1108 may likewise be defined by or associated with a PPDU format for communications by the ambient power wireless device. For example, the uplink PPDU 1108 may be associated with a threshold quantity of bits (such as a maximum number of bits) and the uplink PPDU 1108 may include one or more identifier fields, including an identifier of the receiving device or an identifier of the transmitting device, or both. The uplink PPDU 1108 may further include a control type field and a payload. The uplink PPDU 1108 may optionally include a set of MIC bits (such as overlap MIC bits used for security and authentication of transmissions from the ambient power wireless device) in implementations where a MIC security features is enabled for transmissions from the ambient power wireless device. The uplink PPDU 1108 may further include a set of CRC bits.

In some examples, such as when the one or more energizing signals may be interrupted (such as due to power failure or other events), an ambient power wireless device may default to using the security protocols described herein, for example, with reference to FIG. 10. That is, the uplink PPDU 1108 sent by the ambient power wireless device may be associated with one or more techniques that enable one-shot (for example, per-message) authentication and security for respective messages transmitted by the ambient power wireless device (for example, due to an unexpected absence of the energizing signals used for harvesting). As such, the ambient power wireless device may be configured with and store one or more MSKs and, when the downlink PPDU 1106 querying the ambient power wireless device is received, the ambient power wireless device may generate a random number that is specific to that downlink PPDU 1106. The ambient power wireless device may generate a transient key (for example, a security key) using multiple random numbers, an MSK, and an identifier (for example, a MAC address) associated with the ambient power wireless device.

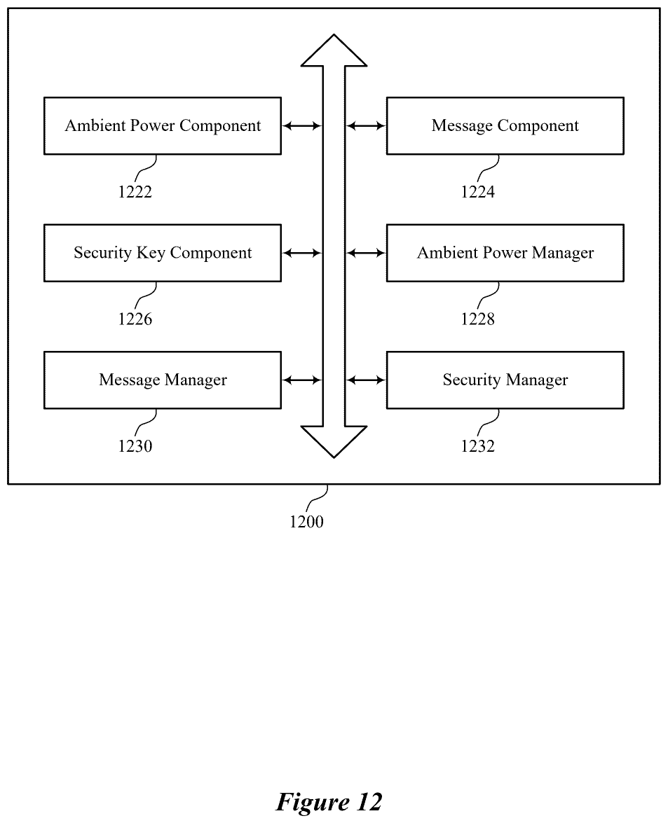

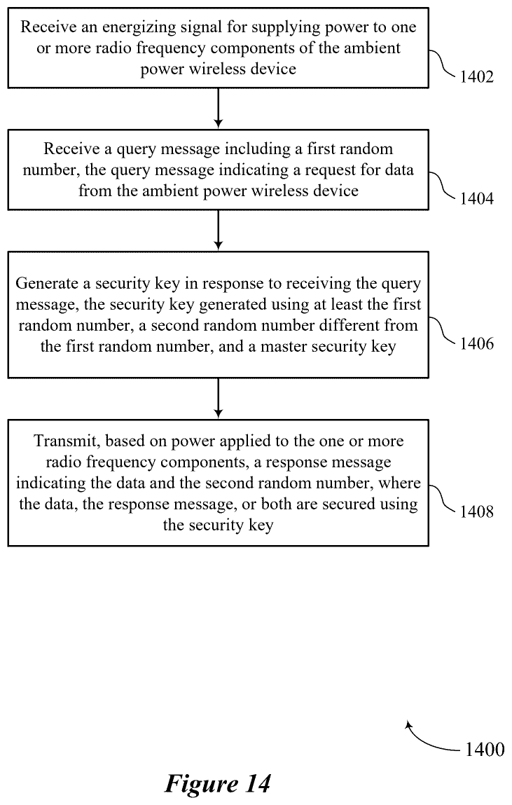

FIG. 12 shows a block diagram of an example wireless communication device 1200 that supports secure signaling techniques for ambient power devices. In some examples, the wireless communication device 1200 is configured to perform the processes 1400, 1500, 1600, and 1700 described with reference to FIGS. 14, 15, 16, and 17, respectively. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1200 may transmit the information output from the chip. In such an example, the second interface may refer to an interface between the processing system of the chip and a reception component, such that the wireless communication device 1200 may receive information that is then passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in a STA, such as the STA 104 described with reference to FIG. 1. Additionally, or alternatively, the wireless communication device 1200 can be configurable or configured for use in an ambient power wireless device (such as an AMP tag, or the like) as described with reference to FIGS. 5A through 5F. In some other examples, the wireless communication device 1200 can be a STA that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes a user interface (UI) (such as a touchscreen or keypad) and a display, which may be integrated with the UI to form a touchscreen display that is coupled with the processing system. In some examples, the wireless communication device 1200 may further include one or more sensors such as, for example, one or more inertial sensors, accelerometers, temperature sensors, pressure sensors, or altitude sensors, which are coupled with the processing system.

The wireless communication device 1200 includes an ambient power component 1222, a message component 1224, a security key component 1226, an ambient power manager 1228, a message manager 1230, and a security manager 1232. Portions of one or more of the ambient power component 1222, the message component 1224, the security key component 1226, the ambient power manager 1228, the message manager 1230, and the security manager 1232 may be implemented at least in part in hardware or firmware. For example, one or more of the ambient power component 1222, the message component 1224, the security key component 1226, the ambient power manager 1228, the message manager 1230, and the security manager 1232 may be implemented at least in part by at least a processor or a modem. In some examples, portions of one or more of the ambient power component 1222, the message component 1224, the security key component 1226, the ambient power manager 1228, the message manager 1230, and the security manager 1232 may be implemented at least in part by a processor and software in the form of processor-executable code stored in memory.

The wireless communication device 1200 may support wireless communications in accordance with examples as disclosed herein. The ambient power component 1222 is configurable or configured to receive an energizing signal for supplying power to one or more radio frequency components of the ambient power wireless device. The message component 1224 is configurable or configured to receive a query message including a first random number, the query message indicating a request for data from the ambient power wireless device. The security key component 1226 is configurable or configured to generate a security key in response to receiving the query message, the security key generated using at least the first random number, a second random number different from the first random number, and a master security key. In some examples, the message component 1224 is configurable or configured to transmit, based on power applied to the one or more radio frequency components, a response message indicating the data and the second random number, where the data, the response message, or both are secured using the security key.

In some examples, the security key component 1226 is configurable or configured to generate the second random number in response to the query message, where the security key is specific to the received query message based on the second random number generated in response to the query message. In some examples, the second random number is generated using a time stamp as a seed.

In some examples, to support generating the security key, the security key component 1226 is configurable or configured to generate the security key based on the first random number, the second random number, the master security key, and an identifier associated with the ambient power wireless device. In some examples, the identifier includes a MAC address.

In some examples, the security key component 1226 is configurable or configured to determine a set of MIC bits based on the security key, where the response message includes the set of MIC bits. In some examples, the set of MIC bits are included in the response message instead of an FCS.

In some examples, the security key component 1226 is configurable or configured to encrypt the response message, the data, or both using the security key.

In some examples, the message component 1224 is configurable or configured to where the response message be transmitted within a time interval of receiving the query message. In some examples, the energizing signal and the query message are received from a same device. In some examples, the energizing signal is received from a first device and the query message is received from a second device different from the first device.

Additionally, or alternatively, the wireless communication device 1200 may support wireless communications in accordance with examples as disclosed herein. The ambient power manager 1228 is configurable or configured to transmit, to an ambient power wireless device, a first query message including an indication of a first random number, the first query message indicating a request for data from the ambient power wireless device. The message manager 1230 is configurable or configured to receive, from the ambient power wireless device, a first response message indicating at least the data and a second random number different from the first random number, where the data, the first response message, or both are secured in accordance with a security key that is based on at least the first random number, the second random number, and a master security key.

In some examples, the message manager 1230 is configurable or configured to receive a second query message from an application server, where transmitting the first query message to the ambient power wireless device is triggered by the second query message. In some examples, the second query message includes an indication of the first random number. In some examples, transmitting the first query message including the first random number is based on receiving the second query message including the indication of the first random number.

In some examples, the message manager 1230 is configurable or configured to transmit a second response message to the application server based on receiving the first response message, the second response message including at least the data and the second random number.

In some examples, the security manager 1232 is configurable or configured to verify that the first response message is from the ambient power wireless device based on the master security key. In some examples, to support verifying that the first response message is from the ambient power wireless device, the security manager 1232 is configurable or configured to decrypt the first response message, the data, or both, based on the security key. In some examples, to support verifying that the first response message is from the ambient power wireless device, the security manager 1232 is configurable or configured to perform an integrity check for the first response message, the data, or both, based on the set of MIC bits.

In some examples, the message manager 1230 is configurable or configured to perform a channel access procedure, where transmitting the first query message and receiving the first response message is based on the channel access procedure. In some examples, the first response message is received within a time interval of transmitting the first query message.

In some examples, the security key is based on the first random number, the second random number, the master security key, and an identifier associated with the ambient power wireless device. In some examples, the identifier includes a MAC address. In some examples, the ambient power manager 1228 is configurable or configured to transmit an energizing signal for supplying power to one or more radio frequency components of the ambient power wireless device, where receiving the first response message is based on transmitting the energizing signal.

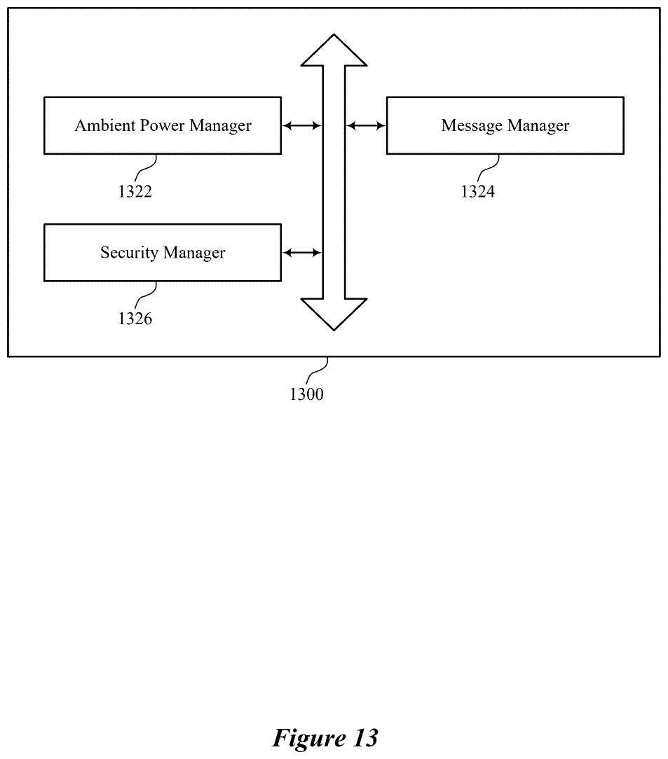

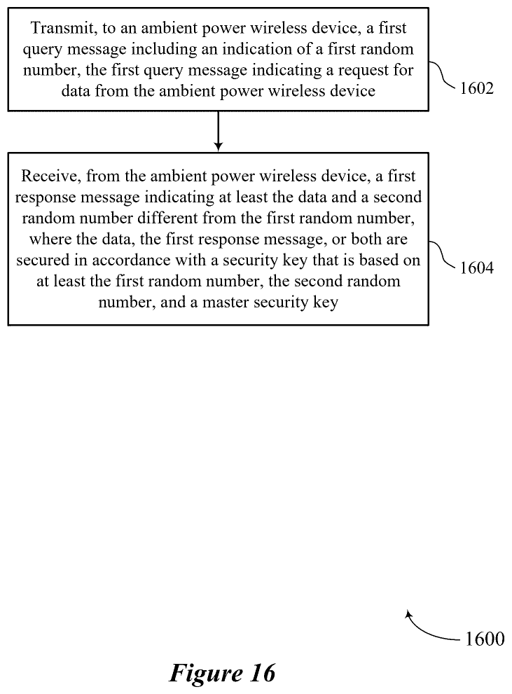

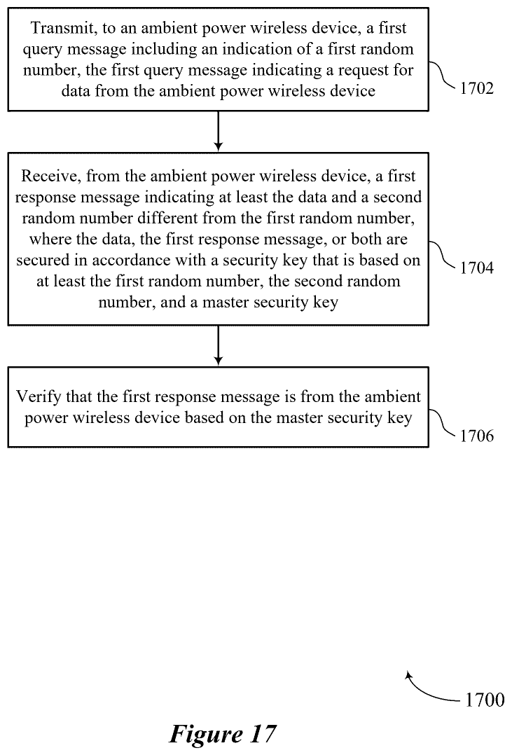

FIG. 13 shows a block diagram of an example wireless communication device 1300 that supports secure signaling techniques for ambient power devices. In some examples, the wireless communication device 1300 is configured to perform the processes 1600 and 1700 described with reference to FIGS. 16 and 17, respectively. The wireless communication device 1300 may include one or more chips, SoCs, chipsets, packages, components or devices that individually or collectively constitute or include a processing system. The processing system may interface with other components of the wireless communication device 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1300 may transmit the information output from the chip. In such an example, the second interface may refer to an interface between the processing system of the chip and a reception component, such that the wireless communication device 1300 may receive information that is then passed to the processing system. In some such examples, the first interface also may obtain information, such as from the transmission component, and the second interface also may output information, such as to the reception component.

The processing system of the wireless communication device 1300 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1300 can be configurable or configured for use in an AP, such as the AP 102 described with reference to FIG. 1. Additionally, or alternatively, the wireless communication device 1300 can be configurable or configured for use in an STA, such as the STA 104 described with reference to FIG. 1. In some other examples, the wireless communication device 1300 can be an AP that includes such a processing system and other components including multiple antennas. The wireless communication device 1300 is capable of transmitting and receiving wireless communications in the form of, for example, wireless packets. For example, the wireless communication device 1300 can be configurable or configured to transmit and receive packets in the form of physical layer PPDUs and MPDUs conforming to one or more of the IEEE 802.11 family of wireless communication protocol standards. In some other examples, the wireless communication device 1300 can be configurable or configured to transmit and receive signals and communications conforming to one or more 3GPP specifications including those for 5G NR or 6G. In some examples, the wireless communication device 1300 also includes or can be coupled with one or more application processors which may be further coupled with one or more other memories. In some examples, the wireless communication device 1300 further includes at least one external network interface coupled with the processing system that enables communication with a core network or backhaul network that enables the wireless communication device 1300 to gain access to external networks including the Internet.

The wireless communication device 1300 includes an ambient power manager 1322, a message manager 1324, and a security manager 1326. Portions of one or more of the ambient power manager 1322, the message manager 1324, and the security manager 1326 may be implemented at least in part in hardware or firmware. For example, one or more of the ambient power manager 1322, the message manager 1324, and the security manager 1326 may be implemented at least in part by at least a processor or a modem. In some examples, portions of one or more of the ambient power manager 1322, the message manager 1324, and the security manager 1326 may be implemented at least in part by a processor and software in the form of processor-executable code stored in memory.

The wireless communication device 1300 may support wireless communications in accordance with examples as disclosed herein. The ambient power manager 1322 is configurable or configured to transmit, to an ambient power wireless device, a first query message including an indication of a first random number, the first query message indicating a request for data from the ambient power wireless device. The message manager 1324 is configurable or configured to receive, from the ambient power wireless device, a first response message indicating at least the data and a second random number different from the first random number, where the data, the first response message, or both are secured in accordance with a security key that is based on at least the first random number, the second random number, and a master security key.

In some examples, the message manager 1324 is configurable or configured to receive a second query message from an application server, where transmitting the first query message to the ambient power wireless device is triggered by the second query message. In some examples, the second query message includes an indication of the first random number. In some examples, transmitting the first query message including the first random number is based on receiving the second query message including the indication of the first random number.

In some examples, the message manager 1324 is configurable or configured to transmit a second response message to the application server based on receiving the first response message, the second response message including at least the data and the second random number.

In some examples, the security manager 1326 is configurable or configured to verify that the first response message is from the ambient power wireless device based on the master security key.

In some examples, to support verifying that the first response message is from the ambient power wireless device, the security manager 1326 is configurable or configured to decrypt the first response message, the data, or both, based on the security key. In some examples, to support verifying that the first response message is from the ambient power wireless device, the security manager 1326 is configurable or configured to perform an integrity check for the first response message, the data, or both, based on the set of MIC bits.

In some examples, the message manager 1324 is configurable or configured to perform a channel access procedure, where transmitting the first query message and receiving the first response message is based on the channel access procedure. In some examples, the first response message is received within a time interval of transmitting the first query message.

In some examples, the security key is based on the first random number, the second random number, the master security key, and an identifier associated with the ambient power wireless device. In some examples, the identifier includes a MAC address.

In some examples, the ambient power manager 1322 is configurable or configured to transmit an energizing signal for supplying power to one or more radio frequency components of the ambient power wireless device, where receiving the first response message is based on transmitting the energizing signal.

FIG. 14 shows a flowchart illustrating an example process 1400 performable by or at an ambient power wireless device that supports secure signaling techniques for ambient power devices. The operations of the process 1400 may be implemented by an ambient power wireless device or its components as described herein. For example, the process 1400 may be performed by a wireless communication device, such as the wireless communication device 1200 described with reference to FIG. 12, operating as or within a wireless STA. In some examples, the process 1400 may be performed by a wireless STA, such as one of the STAs 104 described with reference to FIG. 1. In some examples, the process 1400 may be performed by an ambient power wireless device, such as one or the ambient power wireless devices described with reference to FIGS. 5A-5F.

In some examples, in 1402, the ambient power wireless device may receive an energizing signal for supplying power to one or more radio frequency components of the ambient power wireless device. The operations of 1402 may be performed in accordance with examples as disclosed herein. In some implementations, aspects of the operations of 1402 may be performed by an ambient power component 1222 as described with reference to FIG. 12.

In some examples, in 1404, the ambient power wireless device may receive a query message including a first random number, the query message indicating a request for data from the ambient power wireless device. The operations of 1404 may be performed in accordance with examples as disclosed herein. In some implementations, aspects of the operations of 1404 may be performed by a message component 1224 as described with reference to FIG. 12.

In some examples, in 1406, the ambient power wireless device may generate a security key in response to receiving the query message, the security key generated using at least the first random number, a second random number different from the first random number, and a master security key. The operations of 1406 may be performed in accordance with examples as disclosed herein. In some implementations, aspects of the operations of 1406 may be performed by a security key component 1226 as described with reference to FIG. 12.

In some examples, in 1408, the ambient power wireless device may transmit, based on power applied to the one or more radio frequency components, a response message indicating the data and the second random number, where the data, the response message, or both are secured using the security key. The operations of 1408 may be performed in accordance with examples as disclosed herein. In some implementations, aspects of the operations of 1408 may be performed by a message component 1224 as described with reference to FIG. 12.

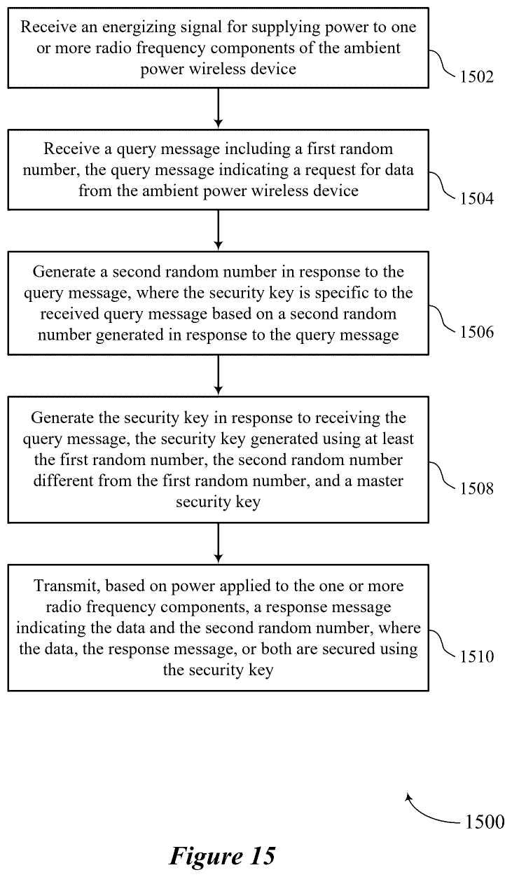

FIG. 15 shows a flowchart illustrating an example process 1500 performable by or at an ambient power wireless device that supports secure signaling techniques for ambient power devices. The operations of the process 1500 may be implemented by an ambient power wireless device or its components as described herein. For example, the process 1500 may be performed by a wireless communication device, such as the wireless communication device 1200 described with reference to FIG. 12, operating as or within a wireless STA. In some examples, the process 1500 may be performed by a wireless STA, such as one of the STAs 104 described with reference to FIG. 1. In some examples, the process 1400 may be performed by an ambient power wireless device, such as one or the ambient power wireless devices described with reference to FIGS. 5A-5F.

In some examples, in 1502, the ambient power wireless device may receive an energizing signal for supplying power to one or more radio frequency components of the ambient power wireless device. The operations of 1502 may be performed in accordance with examples as disclosed herein. In some implementations, aspects of the operations of 1502 may be performed by an ambient power component 1222 as described with reference to FIG. 12.

In some examples, in 1504, the ambient power wireless device may receive a query message including a first random number, the query message indicating a request for data from the ambient power wireless device. The operations of 1504 may be performed in accordance with examples as disclosed herein. In some implementations, aspects of the operations of 1504 may be performed by a message component 1224 as described with reference to FIG. 12.

In some examples, in 1506, the ambient power wireless device may generate a second random number in response to the query message, where a security key is specific to the received query message based on the second random number generated in response to the query message. The operations of 1506 may be performed in accordance with examples as disclosed herein. In some implementations, aspects of the operations of 1506 may be performed by a security key component 1226 as described with reference to FIG. 12.

In some examples, in 1508, the ambient power wireless device may generate the security key in response to receiving the query message, the security key generated using at least the first random number, the second random number different from the first random number, and a master security key. The operations of 1508 may be performed in accordance with examples as disclosed herein. In some implementations, aspects of the operations of 1508 may be performed by a security key component 1226 as described with reference to FIG. 12.

In some examples, in 1510, the ambient power wireless device may transmit, based on power applied to the one or more radio frequency components, a response message indicating the data and the second random number, where the data, the response message, or both are secured using the security key. The operations of 1510 may be performed in accordance with examples as disclosed herein. In some implementations, aspects of the operations of 1510 may be performed by a message component 1224 as described with reference to FIG. 12.

FIG. 16 shows a flowchart illustrating an example process 1600 performable by or at a wireless device that supports secure signaling techniques for ambient power devices. The operations of the process 1600 may be implemented by a wireless device or its components as described herein. For example, the process 1600 may be performed by a wireless communication device, such as the wireless communication device 1200 described with reference to FIG. 12, operating as or within a wireless AP or a wireless STA. In some examples, the process 1600 may be performed by a wireless AP or a wireless STA, such as one of the APs 102 or the STAs 104 described with reference to FIG. 1.

In some examples, in 1602, the wireless communication device may transmit, to an ambient power wireless device, a first query message including an indication of a first random number, the first query message indicating a request for data from the ambient power wireless device. The operations of 1602 may be performed in accordance with examples as disclosed herein. In some implementations, aspects of the operations of 1602 may be performed by an ambient power manager 1228 or an ambient power manager 1322 as described with reference to FIGS. 12 and 13.

In some examples, in 1604, the wireless communication device may receive, from the ambient power wireless device, a first response message indicating at least the data and a second random number different from the first random number, where the data, the first response message, or both are secured in accordance with a security key that is based on at least the first random number, the second random number, and a master security key. The operations of 1604 may be performed in accordance with examples as disclosed herein. In some implementations, aspects of the operations of 1604 may be performed by a message manager 1230 or a message manager 1324 as described with reference to FIGS. 12 and 13.

FIG. 17 shows a flowchart illustrating an example process 1700 performable by or at a wireless device that supports secure signaling techniques for ambient power devices. The operations of the process 1700 may be implemented by a wireless device or its components as described herein. For example, the process 1700 may be performed by a wireless communication device, such as the wireless communication device 1200 described with reference to FIG. 12, operating as or within a wireless AP or a wireless STA. In some examples, the process 1700 may be performed by a wireless AP or a wireless STA, such as one of the APs 102 or the STAs 104 described with reference to FIG. 1.

In some examples, in 1702, the wireless communication device may transmit, to an ambient power wireless device, a first query message including an indication of a first random number, the first query message indicating a request for data from the ambient power wireless device. The operations of 1702 may be performed in accordance with examples as disclosed herein. In some implementations, aspects of the operations of 1702 may be performed by an ambient power manager 1228 or an ambient power manager 1322 as described with reference to FIGS. 12 and 13.

In some examples, in 1704, the wireless communication device may receive, from the ambient power wireless device, a first response message indicating at least the data and a second random number different from the first random number, where the data, the first response message, or both are secured in accordance with a security key that is based on at least the first random number, the second random number, and a master security key. The operations of 1704 may be performed in accordance with examples as disclosed herein. In some implementations, aspects of the operations of 1704 may be performed by a message manager 1230 or a message manager 1324 as described with reference to FIGS. 12 and 13.

In some examples, in 1706, the wireless communication device may verify that the first response message is from the ambient power wireless device based on the master security key. The operations of 1706 may be performed in accordance with examples as disclosed herein. In some implementations, aspects of the operations of 1706 may be performed by a security manager 1232 or a security manager 1326 as described with reference to FIGS. 12 and 13.

Implementation examples are described in the following numbered clauses:

Aspect 1: A method for wireless communications at an ambient power wireless device, including: receiving an energizing signal for supplying power to one or more radio frequency components of the ambient power wireless device; receiving a query message including a first random number, the query message indicating a request for data from the ambient power wireless device; generating a security key in response to receiving the query message, the security key generated using at least the first random number, a second random number different from the first random number, and a master security key; and transmitting, based at least in part on power applied to the one or more radio frequency components, a response message indicating the data and the second random number, where the data, the response message, or both are secured using the security key.

Aspect 2: The method of aspect 1, further including: generating the second random number in response to the query message, where the security key is specific to the received query message based at least in part on the second random number generated in response to the query message.

Aspect 3: The method of aspect 2, where the second random number is generated using a time stamp as a seed.

Aspect 4: The method of any of aspects 1 through 3, where generating the security key includes: generating the security key based at least in part on the first random number, the second random number, the master security key, and an identifier associated with the ambient power wireless device.

Aspect 5: The method of aspect 4, where the identifier includes a medium access control address.

Aspect 6: The method of any of aspects 1 through 5, further including: determining a set of message integrity check bits based at least in part on the security key, where the response message includes the set of message integrity check bits.

Aspect 7: The method of aspect 6, where the set of message integrity check bits are included in the response message instead of a frame check sequence.

Aspect 8: The method of any of aspects 1 through 7, further including: encrypting the response message, the data, or both using the security key.

Aspect 9: The method of any of aspects 1 through 8, further including: where the response message is transmitted within a time interval of receiving the query message.

Aspect 10: The method of any of aspects 1 through 9, where the energizing signal and the query message are received from a same device.

Aspect 11: The method of any of aspects 1 through 10, where the energizing signal is received from a first device and the query message is received from a second device different from the first device.

Aspect 12: A method for wireless communications at a wireless communication device, including: transmitting, to an ambient power wireless device, a first query message including an indication of a first random number, the first query message indicating a request for data from the ambient power wireless device; and receiving, from the ambient power wireless device, a first response message indicating at least the data and a second random number different from the first random number, where the data, the first response message, or both are secured in accordance with a security key that is based at least in part on at least the first random number, the second random number, and a master security key.

Aspect 13: The method of aspect 12, further including: receiving a second query message from an application server, where transmitting the first query message to the ambient power wireless device is triggered by the second query message.

Aspect 14: The method of aspect 13, where the second query message includes an indication of the first random number, transmitting the first query message including the first random number is based on receiving the second query message including the indication of the first random number.

Aspect 15: The method of any of aspects 13 through 14, further including: transmitting a second response message to the application server based at least in part on receiving the first response message, the second response message including at least the data and the second random number.

Aspect 16: The method of any of aspects 12 through 15, further including: verifying that the first response message is from the ambient power wireless device based at least in part on the master security key.

Aspect 17: The method of aspect 16, where the first response message includes a set of message integrity check bits, and where verifying that the first response message is from the ambient power wireless device includes: decrypting the first response message, the data, or both, based at least in part on the security key; and performing an integrity check for the first response message, the data, or both, based at least in part on the set of message integrity check bits.

Aspect 18: The method of any of aspects 12 through 17, further including: performing a channel access procedure, where transmitting the first query message and receiving the first response message is based at least in part on the channel access procedure.

Aspect 19: The method of any of aspects 12 through 18, where the first response message is received within a time interval of transmitting the first query message.

Aspect 20: The method of any of aspects 12 through 19, where the security key is based at least in part on the first random number, the second random number, the master security key, and an identifier associated with the ambient power wireless device.

Aspect 21: The method of aspect 20, where the identifier includes a medium access control address.

Aspect 22: The method of any of aspects 12 through 21, further including: transmitting an energizing signal for supplying power to one or more radio frequency components of the ambient power wireless device, where receiving the first response message is based at least in part on transmitting the energizing signal.

Aspect 23: An ambient power wireless device for wireless communications, including one or more memories storing processor-executable code, and one or more processors coupled with the one or more memories and individually or collectively operable to execute the code to cause the ambient power wireless device to perform a method of any of aspects 1 through 11.

Aspect 24: An ambient power wireless device for wireless communications, including at least one means for performing a method of any of aspects 1 through 11.

Aspect 25: A non-transitory computer-readable medium storing code for wireless communications, the code including instructions executable by one or more processors to perform a method of any of aspects 1 through 11.

Aspect 26: A wireless communication device for wireless communications, including one or more memories storing processor-executable code, and one or more processors coupled with the one or more memories and individually or collectively operable to execute the code to cause the wireless communication device to perform a method of any of aspects 12 through 22.

Aspect 27: A wireless communication device for wireless communications, including at least one means for performing a method of any of aspects 12 through 22.

Aspect 28: A non-transitory computer-readable medium storing code for wireless communications, the code including instructions executable by one or more processors to perform a method of any of aspects 12 through 22.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An ambient power wireless device, comprising:
a processing system that includes processor circuitry and memory circuitry that stores code, the processing system configured to cause the ambient power wireless device to:
receive an energizing signal for supplying power to one or more radio frequency components of the ambient power wireless device;
receive a query message including a first random number, the query message indicating a request for data from the ambient power wireless device;
generate a security key in response to receiving the query message, the security key generated using at least the first random number, a second random number different from the first random number, and a master security key; and
transmit, based at least in part on power applied to the one or more radio frequency components, a response message indicating the data and the second random number, wherein the data, the response message, or both are secured using the security key.

2. The ambient power wireless device of claim 1, wherein the processing system is further configured to cause the ambient power wireless device to:
generate the second random number in response to the query message, wherein the security key is specific to the received query message based at least in part on the second random number generated in response to the query message.

3. The ambient power wireless device of claim 2, wherein the second random number is generated using a time stamp as a seed.

4. The ambient power wireless device of claim 1, wherein, to generate the security key, the processing system is configured to cause the ambient power wireless device to:
generate the security key based at least in part on the first random number, the second random number, the master security key, and an identifier associated with the ambient power wireless device.

5. The ambient power wireless device of claim 4, wherein the identifier comprises a medium access control address.

6. The ambient power wireless device of claim 1, wherein the processing system is further configured to cause the ambient power wireless device to:
determine a set of message integrity check bits based at least in part on the security key, wherein the response message includes the set of message integrity check bits.

7. The ambient power wireless device of claim 6, wherein the set of message integrity check bits are included in the response message instead of a frame check sequence.

8. The ambient power wireless device of claim 1, wherein the processing system is further configured to cause the ambient power wireless device to:
encrypt the response message, the data, or both using the security key.

9. The ambient power wireless device of claim 1, wherein the processing system is further configured to cause the ambient power wireless device to:
wherein the response message be transmitted within a time interval of receiving the query message.

10. The ambient power wireless device of claim 1, wherein the energizing signal and the query message are received from a same device.

11. The ambient power wireless device of claim 1, wherein the energizing signal is received from a first device and the query message is received from a second device different from the first device.

12. A wireless communication device, comprising:
a processing system that includes processor circuitry and memory circuitry that stores code, the processing system configured to cause the wireless communication device to:
transmit, to an ambient power wireless device, a first query message including an indication of a first random number, the first query message indicating a request for data from the ambient power wireless device; and
receive, from the ambient power wireless device, a first response message indicating at least the data and a second random number different from the first random number, wherein the data, the first response message, or both are secured in accordance with a security key that is based at least in part on at least the first random number, the second random number, and a master security key.

13. The wireless communication device of claim 12, wherein the processing system is further configured to cause the wireless communication device to:
receive a second query message from an application server, wherein transmitting the first query message to the ambient power wireless device is triggered by the second query message.

14. The wireless communication device of claim 13, wherein:
the second query message includes an indication of the first random number, and
transmitting the first query message including the first random number is based on receiving the second query message including the indication of the first random number.

15. The wireless communication device of claim 13, wherein the processing system is further configured to cause the wireless communication device to:
transmit a second response message to the application server based at least in part on receiving the first response message, the second response message comprising at least the data and the second random number.

16. The wireless communication device of claim 12, wherein the processing system is further configured to cause the wireless communication device to:
verify that the first response message is from the ambient power wireless device based at least in part on the master security key.

17. The wireless communication device of claim 16, wherein, to verify that the first response message is from the ambient power wireless device, the processing system is configured to cause the wireless communication device to:
decrypt the first response message, the data, or both, based at least in part on the security key; and
perform an integrity check for the first response message, the data, or both, based at least in part on a set of message integrity check bits.

18. The wireless communication device of claim 12, wherein the processing system is further configured to cause the wireless communication device to:
perform a channel access procedure, wherein transmitting the first query message and receiving the first response message is based at least in part on the channel access procedure.

19. The wireless communication device of claim 12, wherein the first response message is received within a time interval of transmitting the first query message.

20. The wireless communication device of claim 12, wherein the security key is based at least in part on the first random number, the second random number, the master security key, and an identifier associated with the ambient power wireless device.

21. The wireless communication device of claim 20, wherein the identifier comprises a medium access control address.

22. The wireless communication device of claim 12, wherein the processing system is further configured to cause the wireless communication device to:
transmit an energizing signal for supplying power to one or more radio frequency components of the ambient power wireless device, wherein receiving the first response message is based at least in part on transmitting the energizing signal.

23. A method for wireless communications at an ambient power wireless device, comprising:
receiving an energizing signal for supplying power to one or more radio frequency components of the ambient power wireless device;
receiving a query message including a first random number, the query message indicating a request for data from the ambient power wireless device;
generating a security key in response to receiving the query message, the security key generated using at least the first random number, a second random number different from the first random number, and a master security key; and
transmitting, based at least in part on power applied to the one or more radio frequency components, a response message indicating the data and the second random number, wherein the data, the response message, or both are secured using the security key.

24. The method of claim 23, further comprising:
generating the second random number in response to the query message, wherein the security key is specific to the received query message based at least in part on the second random number generated in response to the query message.

25. The method of claim 23, wherein generating the security key comprises:
generating the security key based at least in part on the first random number, the second random number, the master security key, and an identifier associated with the ambient power wireless device.

26. The method of claim 23, further comprising:
determining a set of message integrity check bits based at least in part on the security key, wherein the response message includes the set of message integrity check bits.

27. A method for wireless communications at a wireless communication device, comprising:
transmitting, to an ambient power wireless device, a first query message including an indication of a first random number, the first query message indicating a request for data from the ambient power wireless device; and
receiving, from the ambient power wireless device, a first response message indicating at least the data and a second random number different from the first random number, wherein the data, the first response message, or both are secured in accordance with a security key that is based at least in part on at least the first random number, the second random number, and a master security key.

28. The method of claim 27, further comprising:
receiving a second query message from an application server, wherein transmitting the first query message to the ambient power wireless device is triggered by the second query message.

29. The method of claim 28, further comprising:
transmitting a second response message to the application server based at least in part on receiving the first response message, the second response message comprising at least the data and the second random number.

30. The method of claim 27, further comprising:
verifying that the first response message is from the ambient power wireless device based at least in part on the master security key.
